(19) United States
(12) Patent Application Publication
(10) Pub. No.: US 2026/0045188 A1
(43) Pub. Date: Feb. 12, 2026

(54) ELECTRONIC APPARATUS INCLUDING STRETCHABLE DISPLAY PANEL, AND OPERATION METHOD OF THE ELECTRONIC APPARATUS

(71) Applicant: Samsung Display Co., Ltd., Yongin-si (KR)

(72) Inventor: Mankyu Jo, Yongin-si (KR)

(21) Appl. No.: 19/271,528

(22) Filed: Jul. 16, 2025

(30) Foreign Application Priority Data
Aug. 7, 2024 (KR) 10-2024-0105747

(51) Int. Cl. G09G 3/00; G06F 3/01; G06T 3/40; G06T 5/80; G09G 3/3233

(52) U.S. Cl. CPC G09G 3/035; G06F 3/013; G06T 3/40; G06T 5/80; G09G 3/3233; G09G 2300/0819; G09G 2300/0842; G09G 2300/0861; G09G 2320/0233; G09G 2340/0407; G09G 2354/00

(57) ABSTRACT

In an electronic apparatus including a stretchable display panel, the electronic apparatus includes: the stretchable display panel including a display area and a peripheral area outside the display area; a deformation detector configured to detect a deformation direction and deformation rate of the stretchable display panel to generate deformation data; a memory storing a plurality of image data; and at least one processor, wherein the at least one processor is configured to receive the deformation data, to identify an event in which the display area having a first size is stretched to a second size while displaying a first image having the first size, and to control the stretchable display panel to display the first image having the first size on a portion of the display area and display a second image on a remaining portion of the display area.

### CROSS-REFERENCE TO RELATED APPLICATION

The present application claims priority to and the benefit of Korean Patent Application No. 10-2024-0105747, filed on Aug. 7, 2024, in the Korean Intellectual Property Office, the entire disclosure of which is incorporated herein by reference.

### BACKGROUND

### 1. Field

Aspects of some embodiments relate to an electronic apparatus including a stretchable display panel, and an operation method of the electronic apparatus.

### 2. Description of the Related Art

In general, along with the development of display panels that visually display electrical signals, various display panels having characteristics such as having a relatively slim profile, light weight, and low power consumption, and electronic apparatuses including the display panels have been introduced. For example, flexible display panels which may be folded or rolled without damaging the display panels, display panels of various structures (such as, stretchable display panels), and electronic apparatuses including the display panels have been actively researched and developed.

The above information disclosed in this Background section is only for enhancement of understanding of the background and therefore the information discussed in this Background section does not necessarily constitute prior art.

### SUMMARY

In a stretchable display panel, an aspect ratio of a display area may change due to deformation of the display panel, and also a resolution changes due to a change in a distance between pixels. Therefore, images displayed before deformation of the display panel may be distorted after deformation of the display panel. Aspects of one or more embodiments include an electronic apparatus including a stretchable display panel that relatively reduces image distortion caused by deformation of the display panel and provides a new user interface, and an operation method of the electronic apparatus. However, aspects of embodiments according to the present disclosure are not limited thereto, and the above characteristics do not limit the scope of embodiments according to the present disclosure.

Additional aspects will be set forth in portion in the description which follows and, in part, will be apparent from the description, or may be learned by practice of the presented embodiments of the disclosure.

According to some embodiments of the present disclosure, an electronic apparatus includes a stretchable display panel including a display area and a peripheral area outside the display area, a deformation detector configured to detect a deformation direction and deformation rate of the display panel to generate deformation data, a memory storing a plurality of image data, and at least one processor. According to some embodiments, the at least one processor is configured to receive the deformation data, identify an event in which the display area having a first size is stretched to a second size while displaying a first image having the first size, and control the display panel to display the first image having the first size on a portion of the display area and display a second image on a remaining portion of the display area.

According to some embodiments, the at least one processor may be configured to load first image data from the memory while the display area has the first size, generate a display control signal based on the first image data, transmit the display control signal to the display panel, load second image data from the memory while the display area has the second size, generate the display control signal based on the second image data, and transmit the display control signal to the display panel.

According to some embodiments, the first image data may include information of the first image having the first size at a first resolution, and the second image data may include information of the first image having the first size at a second resolution, and information of the second image.

According to some embodiments, each of the first image and the second image may be a portion of one image.

According to some embodiments, the at least one processor may be configured to execute a first software application in a foreground state and execute a second software application in a background state, while the display area has the first size. According to some embodiments, the first image may be a user interface of the first software application, and the second image may be a user interface of the second software application.

According to some embodiments, the at least one processor may be configured to identify a deformation direction of the display panel and determine a location of the first image on the display area according to the deformation direction.

According to some embodiments, the at least one processor may be configured to fix a boundary of the first image at one side of the display area while the display panel is being stretched.

According to some embodiments, the at least one processor may be configured to fix a center portion of the first image at a center portion of the display area while the display panel is being stretched.

According to some embodiments of the present disclosure, an electronic apparatus includes a stretchable display panel including a display area and a peripheral area outside the display area, a panel deformation device configured to stretch or recover the display panel, an eye tracker configured to detect an eye location and an eye movement of a user to generate tracking data, a memory storing a plurality of image data, and at least one processor. According to some embodiments, the at least one processor is configured to receive the tracking data, calculate a deformation direction and a deformation rate of the display panel, based on the tracking data while the display area having a first size is displaying a first image having the first size, control the panel deformation device to have a second size according to the deformation direction and the deformation rate, and control the display panel to display the first image having the first size on a portion of the display area and display a second image on a remaining portion of the display area.

According to some embodiments, the at least one processor may be configured to load first image data from the memory while the display area has the first size, generate a display control signal based on the first image data, transmit the display control signal to the display panel, load second image data from the memory while the display area has the second size, generate the display control signal based on the second image data, and transmit the display control signal to the display panel.

According to some embodiments, the first image data may include information of the first image having the first size at a first resolution, and the second image data may include information of the first image having the first size at a second resolution, and information of the second image.

According to some embodiments, each of the first image and the second image may be a portion of one image.

According to some embodiments of the present disclosure, an operation method of an electronic apparatus including a stretchable display panel includes displaying a first image on a display area having a first size, detecting a deformation direction and deformation rate of the display panel to generate deformation data, loading corresponding image data from a memory according to the deformation data, and displaying the first image having the first size on a portion of the display area stretched to a second size, and displaying a second image on a remaining portion of the display area.

According to some embodiments, in the displaying of the first image on the display area having the first size, the first image may be displayed at a first resolution. In the displaying of the first image on the portion of the display area having the second size and the displaying of the second image on the remaining portion of the display area, the first image and the second image may be displayed at a second resolution less than the first resolution.

According to some embodiments, each of the first image and the second image may be a portion of one image.

According to some embodiments, in the displaying of the first image on the the display area having the first size, a first software application may be executed in a foreground state, a second software application may be executed in a background state, the first image may be a user interface of the first software application, and the second image may be a user interface of the second software application.

According to some embodiments, the displaying of the first image on the portion of the display area having the second size and the displaying of the second image on the remaining portion of the display area may include determining a location of the first image on the display area according to the deformation direction.

According to some embodiments of the present disclosure, an operation method of an electronic apparatus including a stretchable display panel includes displaying a first image on a display area having a first size, detecting an eye location and an eye movement of a user to generate tracking data, wherein the detecting is performed by an eye tracker, calculating a deformation direction and a deformation rate of the display panel, based on the tracking data, controlling the panel deformation device so that the display area has a second size according to the deformation direction and the deformation rate, loading corresponding image data from a memory according to the deformation direction and the deformation rate, and displaying the first image having the first size on a portion of the display area and displaying a second image on a remaining portion of the display area.

According to some embodiments, the displaying of the first image on the display area having the first size may include loading first image data from a memory, generating a display control signal based on the first image data, and transmitting the display control signal to the display panel. According to some embodiments, the displaying of the first image having the first size on the portion of the display area and the displaying of the second image on the remaining portion of the display area may include loading second image data from the memory, generating a display control signal based on the second image data, and transmitting the display control signal to the display panel. According to some embodiments, the first image data may include information of the first image having the first size at a first resolution, and the second image data may include information of the first image having the first size at a second resolution, and information of the second image.

According to some embodiments, the operation method may further include controlling the panel deformation device so that the display area stretched recovers to the first size according to the deformation direction and the deformation rate, loading corresponding image data from a memory according to the deformation direction and the deformation rate, and displaying the first image on the display area having the first size.

These and/or other aspects will become more apparent and more readily appreciated from the following description of the embodiments, taken in conjunction with the accompanying drawings.

These general and specific embodiments may be implemented by using a system, a method, a computer program, or a combination thereof.

### BRIEF DESCRIPTION OF THE DRAWINGS

The above and other aspects, features, and characteristics of certain embodiments of the disclosure will be more apparent from the following description taken in conjunction with the accompanying drawings, in which:

FIG. 1 is a schematic perspective view of a display panel according to some embodiments;

FIGS. 2A and 2B are schematic perspective views of the display panel of FIG. 1 stretched in a first direction;

FIG. 2C is a schematic perspective view of the display panel of FIG. 1 stretched in a second direction;

FIG. 2D is a schematic perspective view of the display panel of FIG. 1 stretched in a first direction and a second direction;

FIG. 2E is a schematic perspective view of the display panel of FIG. 1 stretched in a third direction;

FIG. 3 is a schematic plan view of a display panel according to some embodiments;

FIGS. 4A, 4B, and 4C are equivalent circuit diagrams of one pixel included in a display panel according to some embodiments;

FIGS. 5A and 5B are schematic cross-sectional views of a light-emitting element according to some embodiments;

FIG. 6 is a schematic block diagram of an electronic apparatus according to some embodiments;

FIG. 7 is a schematic block diagram of an electronic apparatus according to some embodiments;

FIG. 8 is a schematic flowchart of an operation method of an electronic apparatus, according to some embodiments;

FIG. 9 is a schematic plan view illustrating the display panel in an initial state, according to some embodiments;

FIG. 10 is a schematic plan view illustrating the display panel of FIG. 9 stretched in the first direction;

FIG. 11A is a schematic plan view of the arrangement of pixels before the display panel is stretched;

FIG. 11B is a schematic plan view of the arrangement of pixels after the display panel is stretched;

FIG. 12 is a schematic plan view of the display panel of FIG. 9 stretched in the first direction;

FIGS. 13A and 13B are schematic plan views of the display panel of FIG. 9 stretched in a fourth direction;

FIG. 14 is a schematic plan view of the display panel of FIG. 9 stretched in the first direction and the fourth direction;

FIG. 15 is a schematic plan view of the display panel of FIG. 9 stretched in four directions;

FIG. 16 is a schematic block diagram of an electronic apparatus according to some embodiments.

FIG. 17 is a schematic flowchart of an operation method of an electronic apparatus, according to some embodiments;

FIGS. 18A through 18C are schematic plan views of a panel deformer according to some embodiments;

FIG. 19A is a schematic view of an electronic apparatus according to some embodiments;

FIG. 19B is a schematic view illustrating the electronic apparatus of FIG. 19A stretched in the first direction;

FIG. 20A is a schematic view of an electronic apparatus according to some embodiments; and

FIG. 20B is a schematic view illustrating the electronic apparatus of FIG. 20A stretched in the second direction and the fourth direction.

### DETAILED DESCRIPTION

Reference will now be made in more detail to aspects of some embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure allows for various changes and numerous embodiments, particular embodiments will be illustrated in the drawings and described in detail in the written description. Hereinafter, effects and features of the disclosure and a method for accomplishing them will be described more fully with reference to the accompanying drawings, in which embodiments of the disclosure are shown. The disclosure may, however, be embodied in many different forms and should not be construed as limited to the embodiments set forth herein.

One or more embodiments will be described below in more detail with reference to the accompanying drawings. Those components that are the same as or are in correspondence with each other are rendered the same reference numeral regardless of the figure number, and redundant explanations are omitted.

It will be understood that although the terms “first,” “second,” etc. may be used herein to describe various components, these components should not be limited by these terms. These components are only used to distinguish one component from another.

As used herein, the singular forms “a,” “an,” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

When a layer, region, or component is referred to as being “formed on” another layer, region, or component, it can be directly or indirectly formed on the other layer, region, or component. That is, for example, intervening layers, regions, or components may be present.

When a layer, region, or component is referred to as being “connected” or “coupled” to another layer, region, or component, it can be directly connected or coupled to the other layer, region, or/and component or intervening layers, regions, or components may be present. For example, when a layer, region, or component is referred to as being “electrically connected” or “electrically coupled” to another layer, region, or component, it can be directly electrically connected or coupled to the other layer, region, and/or component or intervening layers, regions, or components may be present.

An x direction, a y direction, and a z direction used herein are not limited to directions along three axes of a rectangular coordinate system, and may be interpreted in a broader sense. For example, the x direction, the y direction, and the z direction may be perpendicular to one another, or may represent different directions that are not perpendicular to one another.

In the present specification, when referred to “planar”, it means when an object is viewed from above (e.g., when an object is viewed in a direction perpendicular to an upper surface of a substrate), and when referred to “sectional”, it means when a cross section formed by vertically cutting an object is viewed from the side.

In the present specification, a first component “overlapping” a second component refers to the first component being located above or below the second component and accordingly at least partially overlapping the second component.

In the present specification, “ON” or “on” used in association with an element state may be referred to as an activated state of an element, and “OFF” or “off” may be referred to as an inactivated state of an element. “ON” or “on” used in association with a signal received by an element may be referred to as a signal for activating the element, and “OFF” or “off” may be referred to as a signal for inactivating the element. An element may be activated by a high-level voltage or a low-level voltage. For example, a P-channel transistor (P-type transistor) is activated by a low-level voltage, and an N-channel transistor (N-type transistor) is activated by a high-level voltage. Therefore, it should be understood that an “ON” voltage for a P-type transistor and an “ON” voltage for an N-type transistor have opposite (high versus low) voltage levels.

When a certain embodiment may be implemented differently, a specific process order may be performed differently from the described order. For example, two consecutively described processes may be performed substantially at the same time or performed in an order opposite to the described order.

Sizes of elements in the drawings may be exaggerated or reduced for convenience of explanation. For example, because sizes and thicknesses of components in the drawings are arbitrarily illustrated for convenience of explanation, embodiments are not limited thereto.

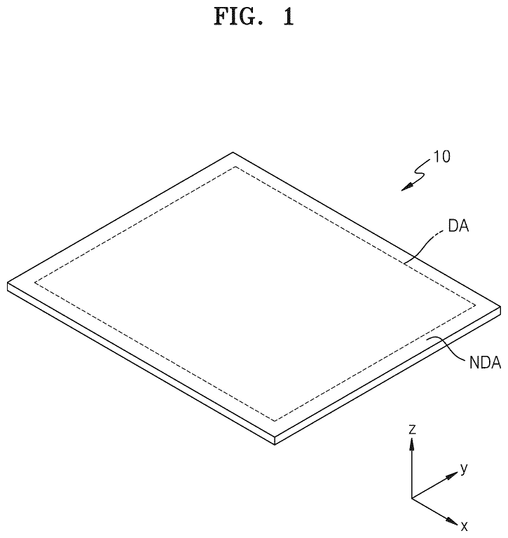

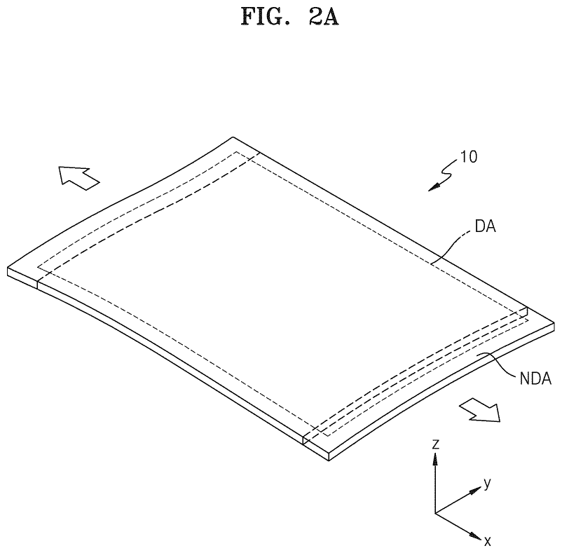

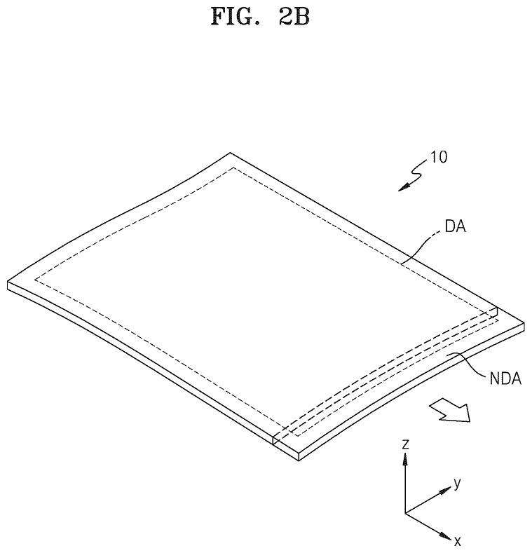

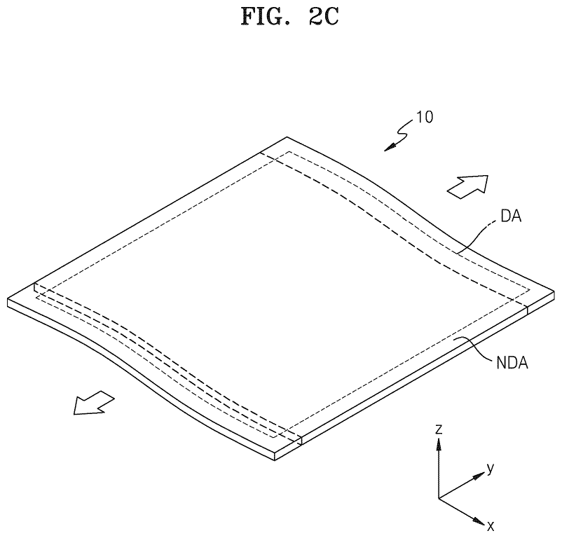

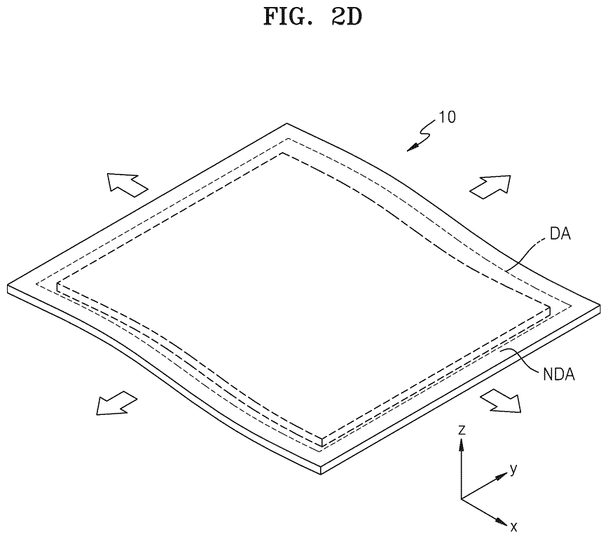

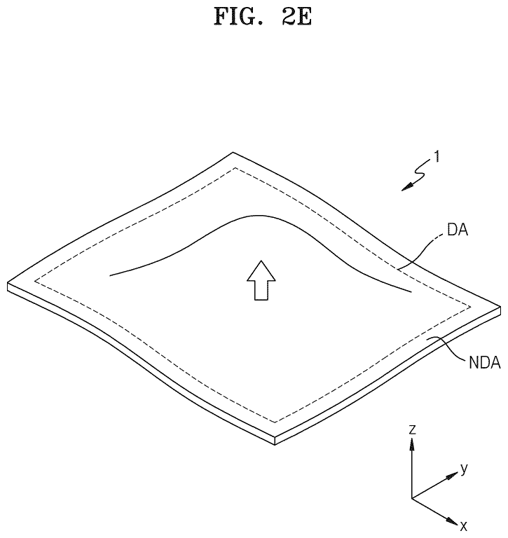

FIG. 1 is a schematic perspective view of a display panel 10 according to some embodiments. FIGS. 2A and 2B are schematic perspective views of the display panel 10 of FIG. 1 stretched in a first direction. FIG. 2C is a schematic perspective view of the display panel 10 of FIG. 1 stretched in a second direction. FIG. 2D is a schematic perspective view of the display panel 10 of FIG. 1 stretched in the first direction and the second direction. FIG. 2E is a schematic perspective view of the display panel 10 of FIG. 1 stretched in a third direction.

Referring to FIG. 1, the display panel 10 may be a stretchable display panel that may stretch or recover in various directions. The display panel 10 may include a display area DA and a non-display area NDA. The display area DA may include a plurality of pixels. The display panel 10 may provide an image by using light emitted by the plurality of pixels. The non-display area NDA may be located outside (e.g., surrounding, in a periphery, or outside a footprint of) the display area DA, and may be referred to as a peripheral area. The non-display area NDA may surround the entirety of the display area DA.

The display panel 10 may be stretched in a first direction (x direction) and/or a fourth direction (−x direction) due to an external force applied by an external object, for example, a human body or a panel deformer. According to some embodiments, as shown in FIGS. 2A and 2B, the display area DA and/or the non-display area NDA of the display panel 10 may be stretched in the first direction (x direction) and the fourth direction (−x direction). For example, as illustrated in FIG. 2A, the display panel 10 may be stretched in the first direction (x direction) and the fourth direction (−x direction), or may be stretched in the first direction (x direction) or the fourth direction (−x direction) with one side of the display panel 1 fixed. FIG. 2B illustrates an example in which one side of the display panel 10 is fixed and the display panel 10 is stretched along the first direction (x direction).

The display panel 10 may be stretched in a second direction (y direction) and/or a fifth direction (−y direction) due to an external force applied by an external object, a portion of a human body, or a panel deformer. According to some embodiments, as shown in FIG. 2C, the display area DA and/or the non-display area NDA of the display panel 10 may be stretched in a second direction (y direction) and a fifth direction (−y direction). According to some embodiments, one side of the display panel 10 may be stretched in the second direction (y direction) or the fifth direction (−y direction).

The display panel 10 may be stretched in a plurality of directions, for example, the first direction (x direction), the second direction (y direction), the fourth direction (−x direction), and the fifth direction (−y direction) due to an external force applied by an external object, a portion of a human body, or a panel deformer. As shown in FIG. 2D, the display area DA and/or the non-display area NDA of the display panel 10 may be stretched in the first direction (x direction), the second direction (y direction), the fourth direction (−x direction), and the fifth direction (−y direction).

The display panel 10 may be stretched in a third direction (z direction) due to an external force applied by an external object, a portion of a human body, or a panel deformer. According to some embodiments, it is shown in FIG. 2E that a portion of the display panel 10, for example, a partial region of the display area DA, protrudes in the third direction (z direction). According to some embodiments, a portion of the display panel 10, for example, a partial region of the display area DA, may protrude in a sixth direction (−z direction) (or may be depressed in the z direction).

FIGS. 2A through 2E illustrate that the display panel 10 is stretched in the first direction (x direction), the second direction (y direction), the third direction (z direction), the fourth direction (−x direction), the fifth direction (−y direction), and/or the sixth direction (−z direction) without damaging the display panel 10. However, embodiments according to the present disclosure are not limited thereto. According to some embodiments, the display panel 10 may be transformed into various irregular shapes such as being bent or twisted along two or more axes without damaging the display panel 10.

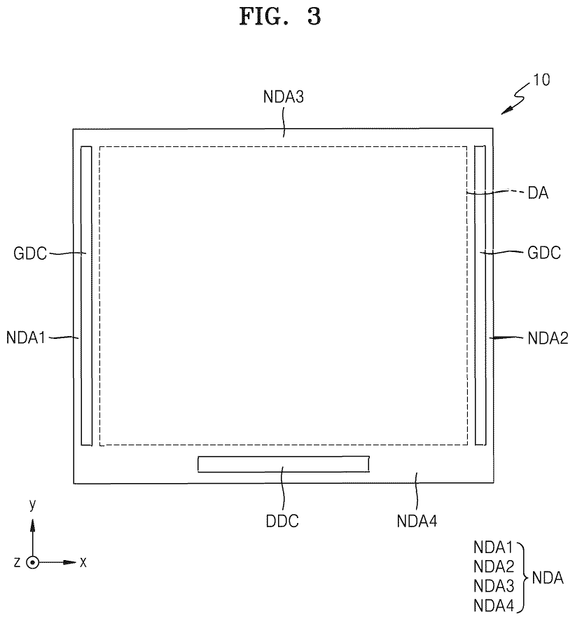

FIG. 3 is a schematic plan view of the display panel 10 according to some embodiments.

Referring to FIG. 3, a plurality of pixels may be arranged in the display area DA of the display panel 10. Each of the plurality of pixels may emit light of different colors to display an image on the display area DA. According to some embodiments, each of the plurality of pixels may emit red light, green light, or blue light. According to some embodiments, each of the plurality of pixels may emit red light, green light, blue light, or white light.

Light-emitting diodes respectively corresponding to the plurality of pixels, and transistors electrically connected to the light-emitting diodes may be arranged in the display area DA. A circuit may be located in the non-display area NDA around the display area DA, wherein the circuit is configured to provide electrical signals to the light-emitting diodes and the transistors arranged in the display area DA. Gate driving circuits GDC may be respectively arranged in a first non-display area NDA1 and a second non-display area NDA2, respectively, arranged on two opposite sides with the display area DA therebetween. The gate driving circuits GDC may include drivers configured to provide electrical signals to a gate electrode of each of the transistors electrically connected to the light-emitting diodes. Although it is shown in FIG. 3 that the gate driving circuits GDC are respectively arranged in the first non-display area NDA1 and the second non-display area NDA2, embodiments are not limited thereto. According to some embodiments, a gate driving circuit GDC may be arranged in one of the first non-display area NDA1 and the second non-display area NDA2.

A data driving circuit DDC may be arranged in a third non-display area NDA3 and/or a fourth non-display area NDA4 each connecting the first non-display area NDA1 to the second non-display area NDA2. According to some embodiments, it is shown in FIG. 3 that the data driving circuit DDC is arranged in the fourth non-display area NDA4. According to some embodiments, data driving circuits DDC may be respectively arranged in the third non-display area NDA3 and the fourth non-display area NDA4.

Although it is shown in FIG. 3 that the data driving circuit DDC is arranged in the fourth non-display area NDA4 of the display panel 10, embodiments are not limited thereto. According to some embodiments, the display panel 10 may further include a flexible circuit board electrically connected through a terminal portion arranged in the fourth non-display area NDA4, and the data driving circuit DDC may be arranged on the flexible circuit board.

According to some embodiments, an elongation rate of the non-display area NDA may be equal to or less than an elongation rate of the display area DA. According to some embodiments, the elongation rate of the non-display area NDA may be different for each region thereof. For example, although the first non-display area NDA1, the second non-display area NDA2, and the third non-display area NDA3 may have substantially the same elongation rates, an elongation rate of the fourth non-display area NDA4 may be less than that of each of the first non-display area NDA1, the second non-display area NDA2, and the third non-display area NDA3.

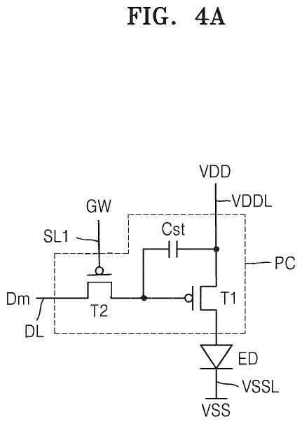

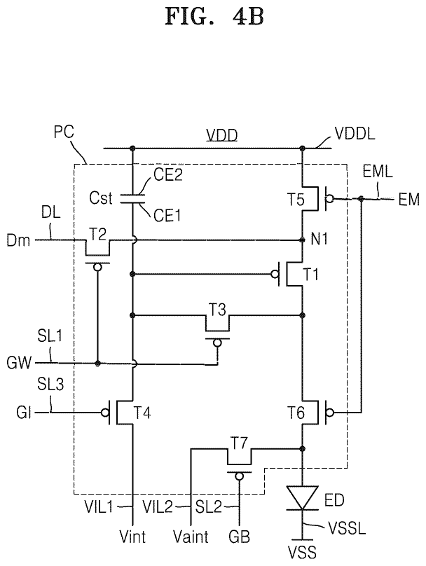

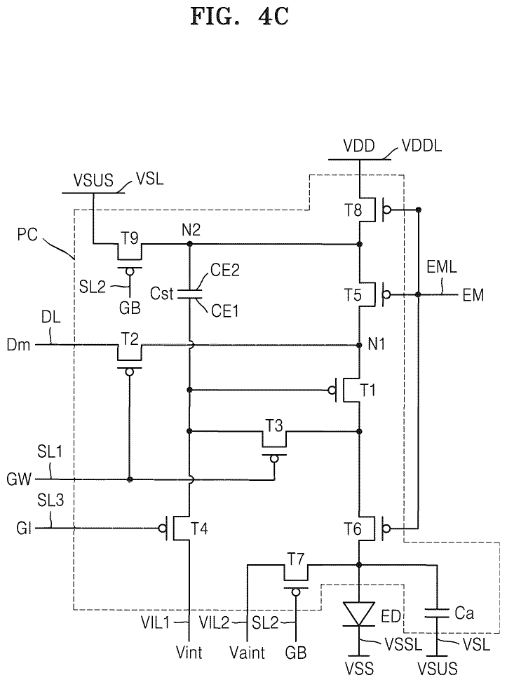

FIGS. 4A, 4B, and 4C are equivalent circuit diagrams of one pixel included in a display panel according to some embodiments. Although FIGS. 4A-4C illustrate various components in pixel according to some embodiments, embodiments according to the present disclosure are not limited thereto, and according to various embodiments, the pixel may include additional components or fewer components without departing from the spirit and scope of embodiments according to the present disclosure.

Referring to FIG. 4A, one pixel may include a light-emitting element ED and a pixel-driving circuit PC electrically connected to the light-emitting element ED. The pixel-driving circuit PC may include a first transistor T1, a second transistor T2, and a storage capacitor Cst. The pixel-driving circuit PC may be electrically connected to signal lines and voltage lines. The signal lines may include a gate line (such as, a first scan line SL1) and a data line DL, and the voltage lines may include a first voltage line (driving power supply voltage line) VDDL.

The second transistor T2 may be electrically connected to the first scan line SL1 and the data line DL. The first scan line SL1 may be configured to provide a first scan signal GW to a gate electrode of the second transistor T2. The second transistor T2 may be a switching transistor that is turned on or turned off according to the first scan signal GW received from the first scan line SL1. The second transistor T2 may be electrically connected to the first transistor T1, and may be configured to transfer a data signal Dm received from the data line DL to the first transistor T1.

The storage capacitor Cst may be electrically connected to the second transistor T2 and the first voltage line VDDL, and may store a voltage corresponding to a difference between a voltage received from the second transistor T2 and a first power supply voltage (e.g., a driving power supply voltage) VDD supplied by the first voltage line VDDL.

The first transistor T1, which is a driving transistor, may be configured to control a driving current flowing through the light-emitting element ED. The first transistor T1 may be connected to the first voltage line VDDL and the storage capacitor Cst. The first transistor T1 may control a driving current flowing from the first voltage line VDDL to the light-emitting element ED according to a voltage stored in the storage capacitor Cst.

The light-emitting element ED may emit light having a corresponding brightness due to the driving current. A first electrode (e.g., an anode) of the light-emitting element ED may be electrically connected to the first transistor T1, and a second electrode (e.g., a cathode) of the light-emitting element ED may be electrically connected to a second voltage line VSSL configured to supply a second power supply voltage (e.g., a common power supply voltage) VSS.

In FIG. 4A, the pixel-driving circuit PC includes two transistors and one storage capacitor. However, according to other embodiments, the pixel-driving circuit PC may include three or more transistors.

Referring to FIG. 4B, the pixel-driving circuit PC may include a first transistor T1, a second transistor T2, a third transistor T3, a fourth transistor T4, a fifth transistor T5, a sixth transistor T6, a seventh transistor T7, and a storage capacitor Cst. The pixel-driving circuit PC is electrically connected to signal lines and voltage lines. The signal lines may include gate lines, such as a first scan line SL1, a second scan line SL2, a third scan line SL3, and a light-emission control line EML, and a data line DL. The voltage lines may include a first initializing voltage line VIL1, a second initializing voltage line VIL2, and the first voltage line VDDL.

The first voltage line VDDL may transmit the first power supply voltage VDD to the first transistor T1. The first initializing voltage line VIL1 may transmit, to the pixel-driving circuit PC, a first initializing voltage Vint that initializes the first transistor T1. The second initializing voltage line VIL2 may transmit, to the pixel-driving circuit PC, a second initializing voltage Vaint that initializes a first electrode of the light-emitting element ED.

The first transistor T1 may be electrically connected to the first voltage line VDDL through the fifth transistor T5, and may be electrically connected to the light-emitting diode ED through the sixth transistor T6. The first transistor T1 serves as a driving transistor, and receives a data signal Dm according to a switching operation of the second transistor T2 and supplies a driving current to the light-emitting element ED. The second through seventh transistors T2 through T7 may be switching transistors that are turned on or off depending on a gate-source voltage or a gate voltage.

The second transistor T2, which is a data write transistor, is electrically connected to the first scan line SL1 and the data line DL. The second transistor T2 is electrically connected to the first voltage line VDDL through the fifth transistor T5. The second transistor T2 is turned on in response to a first scan signal GW received through the first scan line SL1, to perform a switching operation of transmitting the data signal Dm received through the data line DL to the first node N1.

The third transistor T3 is electrically connected to the first scan line SL1, and is electrically connected to the light-emitting element ED via the sixth transistor T6. The third transistor T3 may be turned on in response to the first scan signal SL1 received via the first scan line SL1 and diode-connect the first transistor T1.

The fourth transistor T4, which is a first initialization transistor, is electrically connected to the third scan line SL3 and the first initializing voltage line VIL1. The fourth transistor T4 is turned on in response to a third scan signal GI received through the second scan line SL3, and transmit the first initializing voltage Vint from the first initializing voltage line VIL1 to the gate electrode of the first transistor T1 to thereby initialize the voltage of the gate electrode of the first transistor T1. The third scan signal GI may correspond to a first scan signal of another pixel-driving circuit arranged in a row previous to the row of the current pixel-driving circuit PC.

The fifth transistor T5 may be an operation control transistor, and the sixth transistor T6ay be a light-emission control transistor. The fifth transistor T5 and the sixth transistor T6 are electrically connected to the light-emission control line EML, and are simultaneously turned on in response to a light-emission control signal EM received through the light-emission control line EL and form a current path so that the driving current flows from the first voltage line VDDL toward the light-emitting element ED.

The seventh transistor T7, which is a second initialization transistor, may be electrically connected to the second scan line SL2, the second initializing voltage line VIL2, and the sixth transistor T6. The seventh transistor T7 may be turned on in response to a second scan signal GB received through the second scan line SL2, and may be configured to transfer the second initializing voltage Vaint from the second initializing voltage line VIL2 to the first electrode of the light-emitting element ED to thereby initialize the first electrode of the light-emitting element ED.

The storage capacitor Cst includes a first capacitor electrode CE1 and the second capacitor electrode CE2. The first capacitor electrode CE1 is electrically connected to the gate electrode of the first transistor T1, and the second electrode CE2 is electrically connected to the first voltage line VDDL. The storage capacitor Cst may maintain a voltage applied to the gate electrode of the first transistor T1, by storing and maintaining a voltage corresponding to a difference between the voltage of the first voltage line VDDL and the voltage of the gate electrode of the first transistor T1.

Referring to FIG. 4C, the pixel-driving circuit PC may include a first transistor T1, a second transistor T2, a third transistor T3, a fourth transistor T4, a fifth transistor T5, a sixth transistor T6, a seventh transistor T7, an eighth transistor T8, a ninth transistor T9, a storage capacitor Cst, and an auxiliary capacitor Ca.

The pixel-driving circuit PC is electrically connected to signal lines and voltage lines. The signal lines may include gate lines, such as a first scan line SL1, a second scan line SL2, a third scan line SL3, and a light-emission control line EML, and a data line DL. The voltage lines may include first and second initializing voltage lines VIL1 and VIL2, a sustain voltage line VSL, and the first voltage line VDDL.

The first voltage line VDDL may transmit the first power supply voltage VDD to the first transistor T1. The first initializing voltage line VIL1 may transmit, to the pixel-driving circuit PC, a first initializing voltage Vint that initializes the first transistor T1. The second initializing voltage line VIL2 may transmit, to the pixel-driving circuit PC, a second initializing voltage Vaint that initializes a first electrode of the light-emitting element ED. The sustain voltage line VSL may be configured to provide a sustain voltage VSUS to a second node N2, for example, the second capacitor electrode CE2 of the storage capacitor Cst, during an initialization section and a data-write section.

The first transistor T1 may be electrically connected to the first voltage line VDDL through the fifth transistor T5 and the eighth transistor T8, and may be electrically connected to the light-emitting diode ED through the sixth transistor T6. The first transistor T1 severs as a driving transistor, and may receive a data signal Dm according to a switching operation of the second transistor T2 and supply a driving current to the light-emitting element ED.

The second through ninth transistors T2 through T9 may be switching transistors that are turned on or off depending on the gate-source voltage or the gate voltage.

The second transistor T2 is electrically connected to the first scan line SL1 and the data line DL, and is electrically connected to the first voltage line VDDL via the fifth transistor T5 and the eighth transistor T8. The second transistor T2 is turned on in response to a first scan signal GW received through the first scan line SL1, to perform a switching operation of transmitting the data signal Dm received through the data line DL to the first node N1.

The third transistor T3 is electrically connected to the first scan line SL1, and is electrically connected to the light-emitting element ED via the sixth transistor T6. The third transistor T3 may be turned on in response to the first scan signal GW received through the first scan line SL1 to diode-connect the first transistor T1, thereby compensating for a threshold voltage of the first transistor T1.

The fourth transistor T4 is electrically connected to the third scan line SL3 and the first initializing voltage line VIL1, and is turned on in response to a third scan signal GI received via the third scan line SL3 and transmit the first initializing voltage Vint from the first initializing voltage line VIL1 to the gate electrode of the first transistor T1 to thereby initialize the voltage of the gate electrode of the first transistor T1. The third scan signal GI may correspond to a first scan signal of another pixel-driving circuit arranged in a row previous to the row of the current pixel-driving circuit PC.

The fifth transistor T5, the sixth transistor T6, and the eighth transistor T8 are electrically connected to the light-emission control line EML, and are simultaneously turned on in response to a light-emission control signal EM received through the light-emission control line EL and form a current path so that the driving current flows from the first voltage line VDDL toward the light-emitting element ED.

The seventh transistor T7, which is a second initialization transistor, may be electrically connected to the second scan line SL2, the second initializing voltage line VIL2, and the sixth transistor T6. The seventh transistor T7 is turned on in response to a second scan signal GB received through the second scan line SL2, and is configured to transfer the second initializing voltage Vaint from the second initializing voltage line VIL2 to the first electrode of the light-emitting element ED to thereby initialize the first electrode of the light-emitting element ED.

The ninth transistor T9 may be electrically connected to the second scan line SL2, the second capacitor electrode CE2 of the storage capacitor Cst, and the sustain voltage line VSL. The ninth transistor T9 may be turned on in response to the second scan signal GB transferred through the second scan line SL2, and may be configured to transfer the sustain voltage VSUS to the second node N2, for example, the second capacitor electrode CE2 of the storage capacitor Cst, during the initialization section and the data-write section.

Each of the eighth transistor T8 and the ninth transistor T9 may be electrically connected to the second node N2, for example, the second capacitor electrode CE2 of the storage capacitor Cst. According to some embodiments, during the initialization section and the data-write section, the eighth transistor T8 may be turned off and the ninth transistor T9 may be turned on, and, during an emission section, the eighth transistor T8 may be turned on and the ninth transistor T9 may be turned off. Because, during the initialization section and the data-write section, the sustain voltage VSUS is transferred to the second node N2, uniformity in brightness of a display apparatus (e.g., long range uniformity (LRU)) according to a voltage drop of the first voltage line VDDL may be relatively improved.

The storage capacitor Cst includes a first capacitor electrode CE1 and the second capacitor electrode CE2. The first capacitor electrode CE1 is electrically connected to the gate electrode of the first transistor T1, and the second capacitor electrode CE2 is electrically connected to the eighth transistor T8 and the ninth transistor T9.

The auxiliary capacitor Ca may be electrically connected to the sixth transistor T6, the sustain voltage line VSL, and the first electrode of the light-emitting element ED. While the seventh transistor T7 and the ninth transistor T9 are being turned on, the auxiliary capacitor Ca stores and maintains a voltage corresponding to a difference between the voltage of the first electrode of the light-emitting element ED and the voltage of the sustain voltage line VSL, thereby preventing or reducing instances of a black brightness rising when the sixth transistor T6 is turned off.

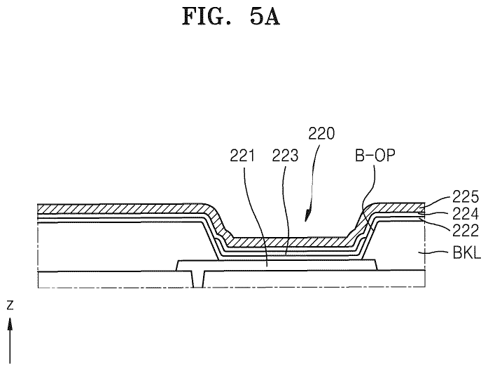

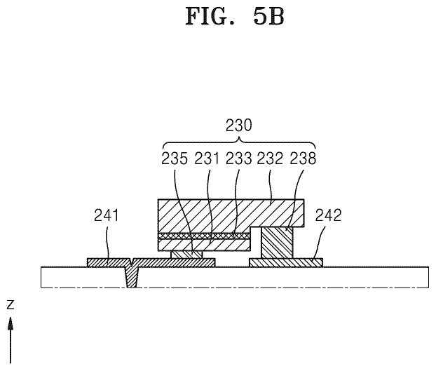

FIGS. 5A and 5B are schematic cross-sectional views of a light-emitting element according to some embodiments.

Referring to FIG. 5A, the light-emitting element according to some embodiments may include an organic light-emitting diode 220 including an organic material. The organic light-emitting diode 220 may include a first electrode 221 located on an insulating layer, a second electrode 225 facing the first electrode 221, and an emission layer 223 interposed between the first electrode 221 and the second electrode 225. A first functional layer 222 may be interposed between the first electrode 221 and the emission layer 223, and a second functional layer 224 may be interposed between the emission layer 223 and the second electrode 225.

An edge of the first electrode 221 may be covered with a bank layer BKL including an insulating material. The bank layer BKL may include an opening B—OP overlapping a center portion of the first electrode 221.

The first electrode 221 may include conductive oxide such as indium tin oxide (ITO), indium zinc oxide (IZO), zinc oxide (ZnO), indium oxide (In₂O₃), indium gallium oxide (IGO), or aluminum zinc oxide (AZO). According to some embodiments, the first electrode 221 may include a reflective layer including silver (Ag), magnesium (Mg), aluminum (Al), platinum (Pt), palladium (Pd), gold (Au), nickel (Ni), neodymium (Nd), iridium (Ir), chromium (Cr), or a compound of these materials. According to some embodiments, the first electrode 221 may further include a layer formed of ITO, IZO, ZnO, or In₂O₃ over/under the reflective layer.

The emission layer 223 may include a low molecular or high molecular organic material that emits light of a certain color. The first functional layer 222 may include a hole transport layer (HTL) and/or a hole injection layer (HIL). The second functional layer 224 may include an electron transport layer (ETL) and/or an electron injection layer (EIL).

The second electrode 225 may include a conductive material having a low work function. For example, the second electrode 225 may include a (semi)transparent layer including, for example, silver (Ag), magnesium (Mg), aluminum (Al), platinum (Pt), palladium (Pd), gold (Au), nickel (Ni), neodymium (Nd), iridium (Ir), chromium (Cr), lithium (Li), calcium (Ca) or an alloy of these materials. Alternatively, the second electrode 225 may further include a layer, such as ITO, IZO, ZnO, AZO, or In₂O₃, on the (semi)transparent layer including any of the above-described materials.

Referring to FIG. 5B, the light-emitting element according to some embodiments may include an inorganic light-emitting diode 230 including an inorganic material. The inorganic light-emitting diode 230 may include a first semiconductor layer 231, a second semiconductor layer 232, an intermediate layer 233 between the first semiconductor layer 231 and the second semiconductor layer 232, a first electrode 235 electrically connected to the first semiconductor layer 231, and a second electrode 238 electrically connected to the second semiconductor layer 232. The first electrode 235 and the second electrode 238 of the inorganic light-emitting diode 230 may be electrically connected to a first electrode pad 241 and a second electrode pad 242, respectively, located on the same layer.

According to some embodiments, the first semiconductor layer 231 may include a p-type semiconductor layer. The p-type semiconductor layer may be selected from semiconductor materials having a composition formula of InₓAl_{y}Ga_{1-x-y}N (0≤x≤1, 0≤y≤1, 0≤x+y≤1), for example, GaN, AlN, AlGaN, InGaN, InN, InAlGaN, and AlInN, and may be doped with a p-type dopant such as Mg, Zn, Ca, Sr, or Ba.

The second semiconductor layer 232 may include, for example, an n-type semiconductor layer. The n-type semiconductor layer may be selected from semiconductor materials having a composition formula of InₓAl_{y}Ga_{1-x-y}N (0≤x≤1, 0≤y≤1, 0≤x+y≤1), for example, GaN, AlN, AlGaN, InGaN, InN, InAlGaN, and AlInN, and may be doped with an n-type dopant such as Si, Ge, or Sn.

The intermediate layer 233, in which electrons and holes are recombined, may transit to a low energy level due to recombination between electrons and holes, and may generate light having a wavelength corresponding to the low energy level. The intermediate layer 233 may be formed by including a semiconductor material having a composition formula of InₓAl_{y}Ga_{1-x-y}N (0≤x≤1, 0≤y≤1, 0≤x+y≤1), and may have a single quantum well structure or a multi-quantum well (MQW) structure. Alternatively, the intermediate layer 233 may have a quantum wire structure or a quantum dot structure.

It has been described with reference to FIG. 5B that the first semiconductor layer 231 includes a p-type semiconductor layer and the second semiconductor layer 232 includes an n-type semiconductor layer, but embodiments are not limited thereto. According to some embodiments, the first semiconductor layer 231 may include an n-type semiconductor layer, and the second semiconductor layer 232 may include a p-type semiconductor layer.

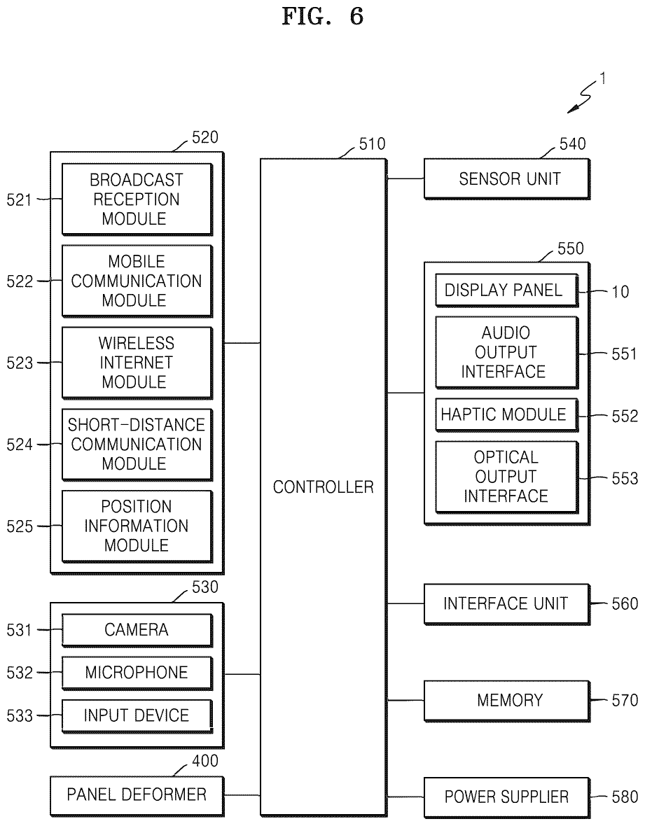

FIG. 6 is a schematic block diagram of an electronic apparatus according to some embodiments.

An electronic apparatus 1 according to some embodiments displays a video or a still image, and thus may be used as the display screens of various products, such as not only portable electronic apparatuses (such as, mobile phones, smartphones, tablet personal computers (PCs), mobile communication terminals, electronic notebooks, electronic books, portable multimedia players (PMPs), navigation devices, and ultra mobile PCs (UMPCs)) but also televisions, notebooks, monitors, advertisement panels, and Internet of things (IoT) devices. The electronic apparatus 1 according to some embodiments may be used in wearable devices, such as smart watches, watch phones, glasses-type displays, and head mounted displays (HMDs). The electronic apparatus 1 according to some embodiments may be used as dashboards of automobiles, center information displays (CIDs) of the center fasciae or dashboards of automobiles, room mirror displays that replace the side mirrors of automobiles, and displays arranged on the rear sides of front seats to serve as entertainment devices for back seat passengers of automobiles.

Referring to FIG. 6, the display panel 10 may further include a controller 510, a wireless communication interface 520, an input interface 530, a sensor unit 540, an output interface 550, an interface unit 560, a memory 570, and/or a power supplier 580.

The controller 510 may control all functions of the electronic apparatus 1. The controller 510 may include at least one processor that performs processing or calculations of various data. The controller 510 may control other components of the electronic apparatus 1, for example, hardware components and/or software components. For example, the controller 510 may output digital image data to a controller of the display panel 10 so that the display panel 10 displays an image. The controller 510 may receive touch sensing data from a touch sensor driver. The controller 510 may determine whether there is a user's touch, according to the touch sensing data, and may execute an operation corresponding to a direct touch or proximity touch of the user. The controller 510 may be an application processor, a central processing unit, or a system chip each realized as an integrated circuit (IC). The controller 510 may include an auxiliary processor that may operate independently of a main processor. According to some embodiments, the auxiliary processor may include a hardware structure specialized for processing an artificial intelligence (AI) model.

The wireless communication interface 520 may include at least one of a broadcast reception module 521, a mobile communication module 522, a wireless Internet module 523, a short-distance communication module 524, or a position information module 525.

The broadcast reception module 521 receives a broadcasting signal and/or broadcasting-related information from an external broadcasting management server via a broadcasting channel. The broadcasting channel may be a satellite channel, a ground wave channel, or the like.

The mobile communication module 522 transmits or receives a wireless signal to or from at least one of a base station, an external terminal, or a server on a mobile communication network established according to technology standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)). Examples of the wireless signal may include a voice call signal, a video call signal, and various types of data according to text/multimedia messages transmission.

The wireless Internet module 523 indicates a module for wireless Internet access. The wireless Internet module 523 may be configured to transmit or receive a wireless signal in a communication network based on the wireless Internet technologies. The wireless Internet technologies may be, for example, a Wireless LAN (WLAN), Wireless-Fidelity (Wi-Fi), Wi-Fi Direct, and Digital Living Network Alliance (DLNA).

The short-distance communication module 524 is for short-range communication, and thus may support short-distance communication by using at least one technology from among Bluetooth™, Radio Frequency Identification (RFID), Infrared Data Association (IrDA), Ultra Wideband (UWB), ZigBee, Near Field Communication (NFC), Wi-Fi, Wi-Fi Direct, and Wireless Universal Serial Bus (Wireless USB). The short-distance communication module 524 may support wireless communication between the electronic apparatus 1 and a wireless communication system, between the electronic apparatus 1 and another electronic apparatus, or between the electronic apparatus 1 and a network where another electronic apparatus (or an external server) is located, through wireless area networks. The wireless area networks may be wireless personal area networks. The other electronic device may be a wearable device capable of exchanging data with (or interoperating with) the electronic apparatus 1.

The position information module 525 is included to obtain a position (or a current position) of the electronic apparatus 1, and thus may include a global positioning system (GPS) module and a Wireless Fidelity (WiFi) module.

The input interface 530 may include an image input interface such as a camera 531 for inputting an image signal, an audio input interface such as a microphone 532 for inputting an audio signal, and an input device 533 for receiving information from a user.

The camera 531 processes an image frame such as a still image or video obtained by an image sensor in a camera mode, and outputs a result of the processing to the controller 510. The camera 531 may include at least one of a camera sensor (for example, a charge-coupled device (CCD) or a complementary metal-oxide-semiconductor (CMOS)), a photo sensor (or an image sensor), or a laser sensor. The camera 531 may be connected to the image sensor from among the components overlapped by the display panel 10, and may process an image input to the image sensor.

The camera 531 processes an image frame such as a still image or video obtained by the image sensor in a video call mode or an image capture mode. A processed image frame corresponding to a result of the processing may be displayed on the display panel 10 or may be stored in the memory 570.

The microphone 532 processes an external audio signal into electrical audio data. The electrical audio data may be used in various ways according to a function currently being performed (or an application currently being executed) in the electronic apparatus 1.

The controller 510 may control an operation of the electronic apparatus 1 to correspond to information that is input via the input device 533. The input device 533 may include a mechanical input unit, such as a button, a dome switch, a jog wheel, and a jog switch each located on a rear or lateral surface of the electronic apparatus 1, or a touch input unit. The touch input unit may be implemented as a touch screen layer of the display panel 10.

The sensor unit 540 may include at least one sensor that senses at least one of information within the electronic apparatus 1, information of a surrounding environment of the electronic apparatus 1, or user information, and generates a sensing signal corresponding to the at least one information. Based on such a sensing signal, the controller 510 may control driving or operation of the electronic apparatus 1 or may perform data processing, a function, or an operation associated with an application provided in the electronic apparatus 1.

According to some embodiments, the sensor unit 540 may include a strain sensor that detects the stretchibility of the display panel 10. The strain sensor may have electrical characteristics and/or optical characteristics that change due to deformation of the display panel 10. According to some embodiments, the strain sensor may be integrally formed with the display panel 10.

According to some embodiments, the sensor unit 540 may include an eye tracking sensor that detects the gaze (e.g., an eye position and an eye movement) of a user who observes the display panel 10. According to some embodiments, the eye tracking sensor may include a near-infrared LED device, and the camera 531 that obtains the reflection pattern of light generated by the user's eye.

The sensor unit 540 may selectively include a proximity sensor, an illumination sensor, an acceleration sensor, a magnetic sensor, a gravity (G)-sensor, a gyroscope sensor, a motion sensor, an RGB sensor, an infrared (IR) sensor, a finger scan sensor, an ultrasonic sensor, an optical sensor, a battery gauge, an environment sensor (e.g., a barometer, a hygrometer, a thermometer, a radiation sensor, a heat sensor, and a gas sensor), and a chemical sensor (e.g., an electronic nose, a healthcare sensor, and a biometric sensor).

The output interface 550 is to generate an output associated with sight, hearing, or tactile sense, and thus may include at least one of the display panel 10, an audio output interface 551, a haptic module 552, or an optical output interface 553.

The display panel 10 displays (outputs) information that is processed by the electronic apparatus 1. For example, the display panel 10 may display execution screen information of an application being driven by the electronic apparatus 1, or may display user interface (UI) and graphical user interface (GUI) information based on the execution screen information. The display panel 10 may include a display layer that displays an image, and a touch screen layer that senses a touch input of a user.

Accordingly, the display panel 10 may function as the input device 533 providing an input interface between the electronic apparatus 1 and a user, and also function as the output interface 550 providing an output interface between the electronic apparatus 1 and the user.

The audio output interface 551 may output audio data received from the wireless communication interface 520 in a call signal reception mode, a call or recording mode, a voice recognition mode, a broadcast reception mode, and the like or stored in the memory 570. The audio output interface 551 also outputs an audio signal related with a function performed by the electronic apparatus 1 (for example, a call signal receiving sound or a message receiving sound). The audio output interface 551 may include a receiver and a speaker. A least one of the receiver and the speaker may be an audio generation device that is attached to a lower portion of the display panel 10 and vibrates the display panel 10 to output an audio. The audio generation device may be a piezoelectric element or piezoelectric actuator that shrinks and expands according to an electrical signal, or an exciter that generates a magnetic force by using a voice coil and vibrates the display panel 10.

The haptic module 552 generates various tactile effects that a user may feel. The haptic module 552 may provide a user with vibration as a tactile effect. The haptic module 552 may transmit a tactile effect through direct contact, and may also be implemented such that a user may feel a tactile effect through a muscle sense such as a finger or an arm.

The optical output interface 553 outputs a signal for notifying occurrence of an event, by using the light of a light source. Examples of the event generated in the electronic apparatus 1 may include message reception, call signal reception, a missed call, an alarm, schedule notification, e-mail reception, and information reception through an application. The signal output by the optical output interface 553 is implemented as the electronic apparatus 1 emits light of a single color or light beams of a plurality of colors to its front surface or rear surface. The outputting of the signal may be terminated when the electronic apparatus 1 senses that a user confirms an event.

The interface unit 560 serves as a passage with various types of external apparatuses that are connected to the electronic apparatus 1. The interface unit 560 may include at least one of a wired/wireless headset port, an external charger port, a wired/wireless data port, a memory card port, a port connecting a device including an identification module, an audio input/output (I/O) port, a video I/O port, or an earphone port. When an external apparatus is connected to the interface unit 560, the electronic apparatus 1 may perform an appropriate control related with the connected external apparatus.

The memory 570 may store data that supports various functions of the electronic apparatus 1. The memory 570 may store a plurality of application programs driven by the electronic apparatus 1, pieces of data for operations of the electronic apparatus 1, and instructions. At least some of the plurality of application programs may be downloaded from an external server through wireless communication.

The memory 570 may store an application for an operation of the controller 510, and may temporarily store input/output data, for example, a phone book, a message, a still image, and a video. The memory 570 may include a plurality of image data corresponding to a deformed shape of the display panel 10 in order to relatively reduce or prevent deformation of an image displayed by the display panel 10 when the display panel 10 is deformed. The memory 570 may also store haptic data for various patterns of vibration that are provided to the haptic module 552, and audio data about various audios that are provided to the audio output interface 551.

The memory 570 may include at least one type of storage medium selected from among a flash memory type, a hard disk type, a solid state disk (SSD) type, a silicon disk drive (SDD) type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk.

Under a control by the controller 510, the power supplier 580 receives external power and internal power and supply the external and internal power to the components included in the electronic apparatus 1. The power supplier 580 may include a battery. The power supplier 580 includes a connection port that may be an example of the interface unit 560 to which an external charger supplying power to charge the battery is electrically connected. Alternatively, the power supplier 580 may be configured to charge the battery in a wireless manner without using a connection port.

According to some embodiments, the electronic apparatus 1 may selectively further include a panel deformer 400. The panel deformer 400 may include at least one arm that stretches or recovers in one direction. The panel deformer 400 may stretch or recover (e.g., contract) the display panel 10 in response to a control signal from the controller 510. The panel deformer 400 may be omitted. In this case, the electronic apparatus 1 may be deformed by the user's hand, etc.

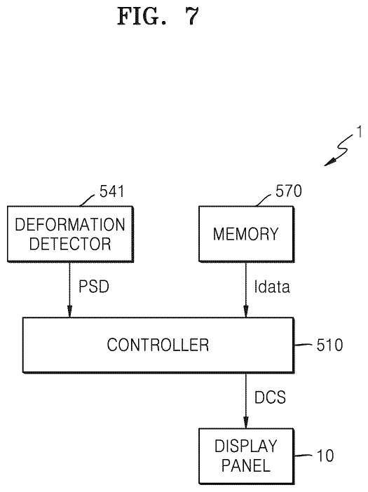

FIG. 7 is a schematic block diagram of the electronic apparatus 1 according to some embodiments.

FIG. 7 illustrates only selected components of the electronic apparatus 1 in order to explain an operation of the electronic apparatus 1 according to some embodiments.

Referring to FIG. 7, the electronic apparatus 1 may include the stretchable display panel 10, the controller 510, a deformation detector 541, and the memory 570.

The display panel 10 may include the display area DA and the non-display area NDA outside the display area DA. The display panel 10 may display an image by using pixels arranged in the display area DA. The display panel 10 may be stretched due to an external force applied by an external object or a user. When no external force is applied to the display panel 10, the display panel 10 may recover to its original state.

The deformation detector 541 may detect a deformation direction and deformation rate of the display panel 10 to generate deformation data PSD. The deformation rate may include an elongation rate of the display panel 10 in the first direction (x direction) and an elongation rate thereof in the second direction (y direction). The deformation detector 541 may include a strain sensor of which electrical or optical characteristics change according to deformation of the display panel 10. The deformation detector 541 may measure a change in the electrical characteristics or optical characteristics of the strain sensor, convert the measured change into the deformation data PSD, which is an electrical signal, and transmit the deformation data PSD to the controller 510. The deformation data PSD may include information about the deformation direction and deformation rate of the display panel 10.

The memory 570 may store software applications, and various data used to run the software applications. The memory 570 may store a plurality of image data Idata. The plurality of image data Idata may include image data pre-stored in correspondence with the deformation direction and deformation rate of the display panel 10.

The controller 510 may include at least one processor. The controller 510 may receive the deformation data PSD from the deformation detector 541, and identify an event in which the display panel 10 stretches or recovers (or is restored). The controller 510 may load image data Idata corresponding to the deformation direction and deformation rate of the display panel 10. The controller 510 may transmit the loaded image data Idata to the display panel 10, and the display panel 10 may display an image.

Before the display panel 10 is elongated, the display area DA may have a first size (or a first area). Before the elongation, the display panel 10 may have a first resolution. The controller 510 may load first image data from the memory 570 and transmit the first image data to the display panel 10. The display panel 10 may display a first image corresponding to the first image data on the entire surface of the display area DA. The image may refer to a visual representation that is displayed on the display panel 10 and recognized by the user. For example, a first image displayed at a first resolution and a first image displayed at a second resolution may be recognized as the same images by a user.

After the display panel 10 is elongated, the display area DA may have a second size (or a second area). Although the size of the display area DA increases, the number of pixels arranged in the display area DA does not change, so the elongated display panel 10 may have the second resolution that is less than the first resolution. The controller 510 may load second image data corresponding to the deformation direction and deformation rate of the display panel 10 from the memory 570, generate a display control signal DCS, based on the second image data, and transmit the display control signal DCS to the display panel 10. The second image data may include information corresponding to a first image having a first size at a second resolution, and information corresponding to a second image displayed outside the first image. The display panel 10 may display the first image having the first size on a portion of the display area DA and display the second image on a remaining portion of the display area DA, in correspondence with the second image data.

When an external force applied to the display panel 10 disappears or decreases, the stretched display panel 10 may recover to its initial state, and the display area DA may have the first size again. The controller 510 may receive the deformation data PSD from the deformation detector 541, and identify an event in which the display panel 10 recovers. The controller 510 may load the image data Idata corresponding to the deformation direction and deformation rate of the display panel 10 from the memory 570, and may transmit the loaded image data Idata to the display panel 10. The display panel 10 may display the first image having the first size on the display area DA. Accordingly, even when the display panel 10 is stretched or recovered, the first image is displayed with the substantially same size, and the second image with new information may be displayed on an area expanded by stretching of the display panel 10.

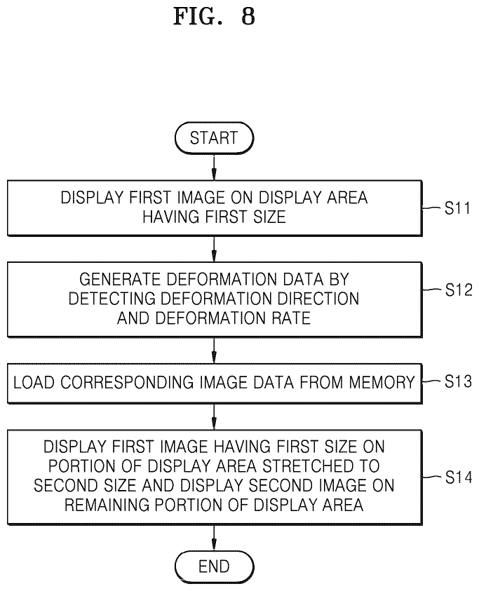

FIG. 8 is a schematic flowchart illustrating aspects of an operation method of the electronic apparatus 1, according to some embodiments. Although FIG. 8 illustrates various operations in an operation method of an electronic device according to some embodiments of the present disclosure, embodiments are not limited thereto, and according to some embodiments, there may be additional operations, or fewer operations, or the order of operations may vary, unless otherwise stated or implied, without departing from the spirit and scope of embodiments according to the present disclosure.

Referring to FIG. 8, the operation method of the electronic apparatus 1, according to some embodiments, may include operation S11 of displaying a first image on a display area having a first size, operation S12 of generating deformation data by detecting a deformation direction and a deformation rate, operation S13 of loading corresponding image data from a memory, and operation S14 of displaying the first image having the first size on a portion of the display area stretched to a second size and displaying a second image on the remaining portion of the display area.

In operation S11 of displaying the first image on the display area DA having the first size, the controller 510 may be configured to load the first image data corresponding to an initial state from the memory 570 and transmit the display control signal DCS based on the first image data to the display panel 10. The first image data may include information of the first image having the first size at the first resolution. The display panel 10 may display the first image having the first size on the entire surface of the display area DA.

In operation S12 of generating the deformation data PSD by detecting the deformation direction and the deformation rate, the deformation detector 541 may detect a change in the electrical characteristics and/or optical characteristics of the strain sensor, convert the detected change into the deformation data PSD, which is an electrical signal, and transmit the deformation data PSD to the controller 510. The deformation data PSD may include information about the deformation direction and deformation rate of the display panel 10.

In operation S13 of loading corresponding image data Idata from the memory 570, the controller 510 may receive the deformation data PSD and load the image data Idata corresponding to the deformation direction and the deformation rate of the display panel 10 from the memory 570. For example, the controller 510 may identify an event in which the display panel 10 has stretched such that the display area DA has the second size, and load second image data. The second image data may include information of the first image having the first size at the second resolution, and information of the second image displayed outside the first image.

In operation S14 of displaying the first image having the first size on the portion of the display area stretched to the second size and displaying the second image on the remaining portion, the controller 510 may transmit the display control signal DCS based on the second image data to the display panel 10, and the display panel 10 may display the first image having the first size on the portion of the display area DA and display the second image on the remaining portion.

The electronic apparatus 1 may repeat each operation during the elongation of the display panel 10. Accordingly, a user may recognize that, while the display panel 10 is being stretched, the first image is displayed with the substantially same size without distortion and the second image with new information is displayed on an expanded area by stretching of the display panel 10.

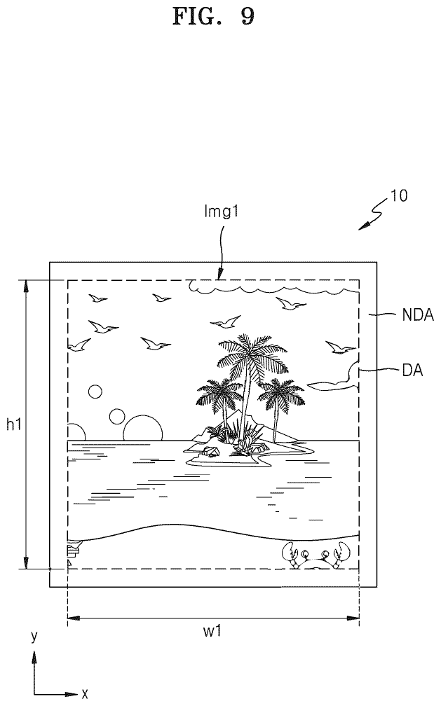

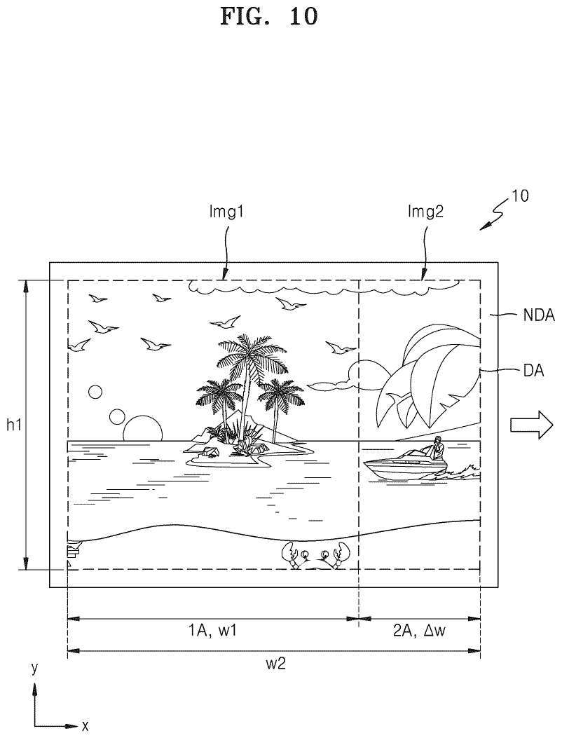

FIG. 9 is a schematic plan view illustrating the display panel 10 in an initial state according to some embodiments, and FIG. 10 is a schematic plan view illustrating the display panel 10 of FIG. 9 stretched in the first direction.

Referring to FIG. 9, the display panel 10 may include the display area DA and the non-display area NDA outside the display area DA. Before the display panel 10 is stretched, the display panel 10 is in an initial state, and the display area DA may have the first size. For example, the display area DA may have a first width w1 in the first direction (x direction) and may have a first height h1 in the second direction (y direction). The display panel 10 may have a first resolution.

The controller 510 may load the first image data from the memory 570 and transmit the first image data to the display panel 10. The first image data may include information of a first image Img1 having the first size at the first resolution. The display panel 10 may display the first image Img1 having the first width w1 and the first height h1 on the entire surface of the display area DA. The first image Img1 may be a portion of a user interface of a first software application that is executed in a foreground state.

Referring to FIG. 10, the display panel 10 may be stretched by an elongation width Δw in the first direction (x direction). The display area DA of the stretched display panel 10 may have a second width w2 in the first direction (x direction) and may have the first height h1 in the second direction (y direction). Because the number of pixels arranged in the display area DA of the display panel 10 does not change, the stretched display panel 10 may have the second resolution that is less than the first resolution.

The deformation detector 541 may generate the deformation data PSD including information on the deformation direction and deformation rate of the display panel 10 by using a strain sensor, and transmit the generated deformation data PSD to the controller 510. The controller 510 may identify, from the deformation data PSD, an event in which the display area DA is stretched to have the second width w2 in the first direction (x direction) and the first height h1 in the second direction (y direction), and may load the second image data corresponding to the deformation direction and deformation rate of the display panel 10 from the memory 570. The second image data may include information of the first image Img1 having the first size at the second resolution, and information of a second image Img2. The controller 510 may generate the display control signal DCS, based on the second image data, and may transmit the display control signal DCS to the display panel 10. The display panel 10 may display the first image Img1 having a first size on a first area 1A, which is a portion of the display area DA, and may display the second image Img2 on a second area 2A, which is the remaining portion of the display area DA.

The first area 1A may have a first size that is substantially the same as the size (or area) of the display area DA of the display panel 10 in the initial state. The first area 1A may have the first width w1 in the first direction (x direction) and may have the first height h1 in the second direction (y direction). Accordingly, even on the stretched display panel 10, the first image Img1 may be displayed in substantially the same size as a size before the display panel 10 is stretched. The second area 2A, which is a portion of the display area DA of the display panel 10, may be an area outside the first area 1A. The second area 2A may have an elongation width Δw in the first direction (x direction) and may have the first height h1 in the second direction (y direction).

According to some embodiments, the second image Img2 may be a portion of a user interface of a first software application that is executed in a foreground state. Each of the first image Img1 and the second image Img2 may be a portion of one image. For example, as illustrated in FIG. 10, the first image Img1 may be a left portion of the entire image, and the second image Img2 may be a right portion of the entire image. The second image Img2 may be an image that is continuous from a right boundary of the first image Img1. Therefore, a user may recognize that a hidden portion of the entire image is displayed when the display panel 10 is stretched in the first direction (x direction). The electronic apparatus 1 according to some embodiments may provide a seamless user experience.

The controller 510 may identify the deformation direction of the display panel 10, based on the deformation data PSD, and may determine a location of the first image Img1 on the display area DA according to the deformation direction of the display panel 10. For example, when the controller 510 identifies an event in which the display panel 10 is stretched in the first direction (x direction), the controller 510 may control the display panel 10 so that the first area 1A on which the first image Img1 is displayed is fixed on a left side (−x side) of the display area DA. That is, the controller 510 may load image data indicating that the first image Img1 is located on the left side (−x side) of the display area DA, from among the plurality of image data, and transmit the loaded image data to the display panel 10.

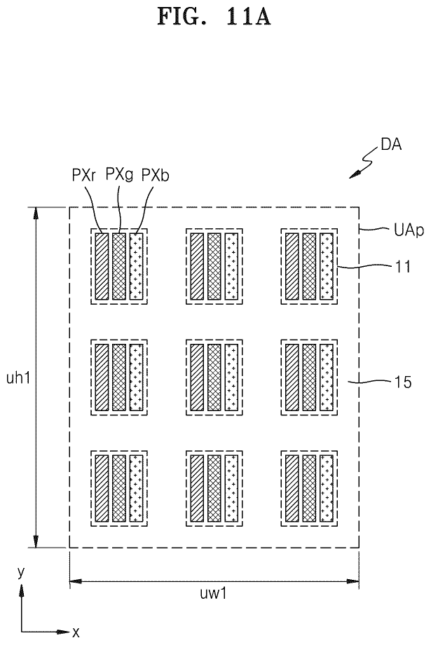

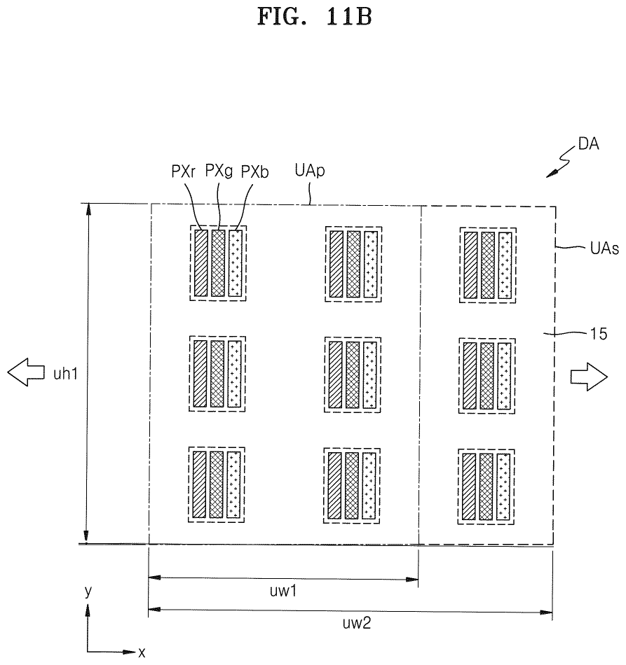

FIG. 11A is a schematic plan view of the arrangement of pixels before the display panel DA is stretched, and FIG. 11B is a schematic plan view of the arrangement of pixels after the display panel DA is stretched.

Referring to FIG. 11A, a plurality of pixels PXr, PXg, and PXb may be arranged in the display area DA of the display panel 10. The display area DA may include a pixel area 11 and a connection area 15 outside the pixel area 11. A red pixel PXr, a green pixel PXg, and a blue pixel PXb may be arranged in the pixel area 11.

Wires may be arranged in the connection area 15. The connection area 15 may be stretched relatively more than the pixel area 11, when the display panel 10 is stretched. According to some embodiments, the connection area 15 may include openings defined in a substrate, in order to deform the display panel 10. According to some embodiments, the substrate of the display panel 10 may include an elastic body, and the opening of the connection area 15 may be omitted. The pixel areas 11 may be arranged at regular intervals in the first direction (x direction) and the second direction (y direction).

An area where 3×3 pixel areas 11 are arranged in the original state where the display panel 10 is not stretched may be defined as a unit area UAp before stretching. The unit area UAp before stretching may have a first width uw1 in the first direction (x direction) and may have a first height uh1 in the second direction (y direction).

Referring to FIG. 11B, the display panel 10 may be stretched in the first direction (x direction) and/or the fourth direction (−x direction). An area where 3×3 pixel areas 11 are arranged in a state where the display panel 10 is stretched may be defined as a unit area UAs after stretching. The unit area UAs, after stretching, may have a second width uw2 in the first direction (x direction) and may have the first height uh1 in the second direction (y direction). The second width uw2 may be greater than the first width uw1.

FIGS. 11A and 11B illustrate that the unit area UAs after stretching has the first height uh1 in the second direction (y direction) likewise the unit area (UAp) before stretching, but embodiments are not limited thereto. When the display panel 10 is stretched in the first direction (x direction) and/or the fourth direction (−x direction), the display panel 10 may be contracted in the second direction (y direction) and/or the fifth direction (−y direction). In this case, a width of the unit area UAs after stretching in the second direction (y direction) may be less than the first height uh1.

In a state where the display panel 10 is stretched, only a smaller number of pixel areas 11, for example, 2×3 pixel areas 11, may be arranged in an area of the same size as a size of the unit area UAp before stretching. That is, the number of pixels arranged in an area of the same size in a stretched display panel 10 may be less than that in a display panel 10 not yet stretched. A resolution of the stretched display panel 10 may be less than that of the not-yet-stretched display panel 10. Therefore, in order to display the first image Img1 of substantially the same size even when the display panel 10 is deformed, the controller 510 needs to load the image data Idata corresponding to the deformation rate of the display panel 10.

Although FIGS. 11A and 11B illustrate a case where the display panel 10 is stretched in the first direction (x direction) and the fourth direction (−x direction), embodiments are not limited thereto. The display panel 10 may stretch or recover in the first direction (x direction), the second direction (y direction), the fourth direction (−x direction), and/or the fifth direction (−y direction), and accordingly, the resolution of the display panel 10 may change.

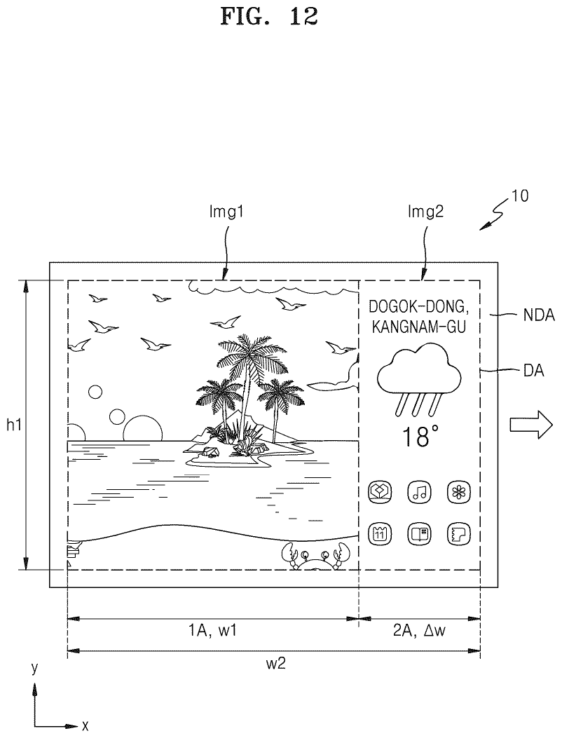

FIG. 12 is a schematic plan view of a state in which the display panel 10 of FIG. 9 is stretched in the first direction.

Referring to FIG. 12, the display area DA of the stretched display panel 10 may have a second size. The display area DA may have the second width w2 in the first direction (x direction) and may have the first height h1 in the second direction (y direction). The first area 1A may have a first size. The first area 1A may have the first width w1 in the first direction (x direction) and may have the first height h1 in the second direction (y direction). The second area 2A may have the elongation width Δw in the first direction (x direction) and may have the first height h1 in the second direction (y direction).

The second image Img2 displayed on the second area 2A may be an image that is not continuous with the first image Img1 displayed on the first area 1A. According to some embodiments, at least one processor included in the controller 510 may be configured to execute a first software application in a foreground state and a second software application in a background state while the display area DA has a first size (e.g., the display panel is in the initial state).

The first image Img1 may be a user interface of the first software application, and the second image Img2 may be a user interface of the second software application. When the display panel 10 is stretched, the second software application may be displayed on the display area DA of the display panel 10. That is, the user interface of the first software application may be provided in the first area 1A of the stretched display panel 10, and the user interface of the second software application may be provided in the second area 2A of the stretched display panel 10.

FIG. 12 illustrates that the second software application provides weather information and favorites of other software applications are provided, but embodiments are not limited thereto. The second software application may be a variety of applications, such as a note-taking application and an Internet search application.

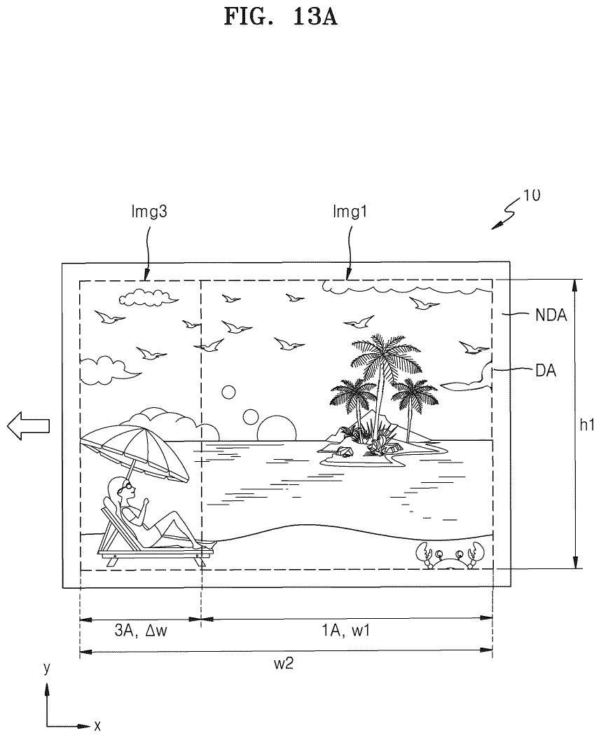

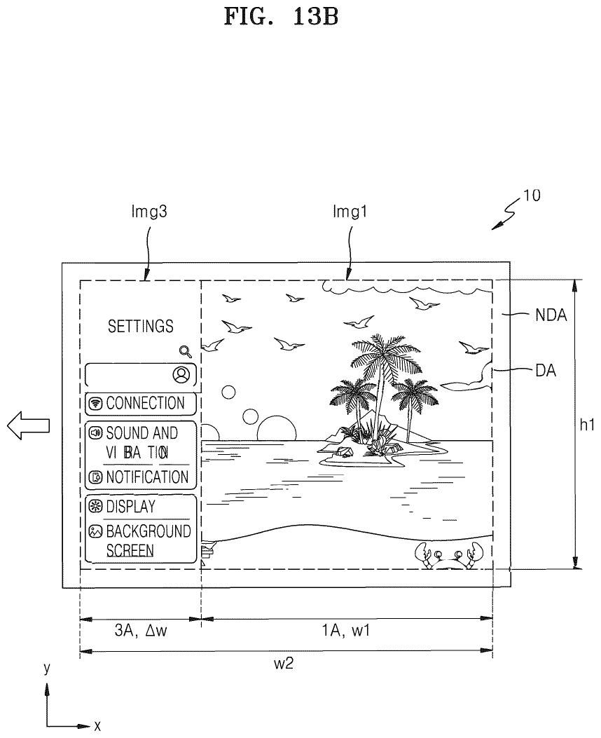

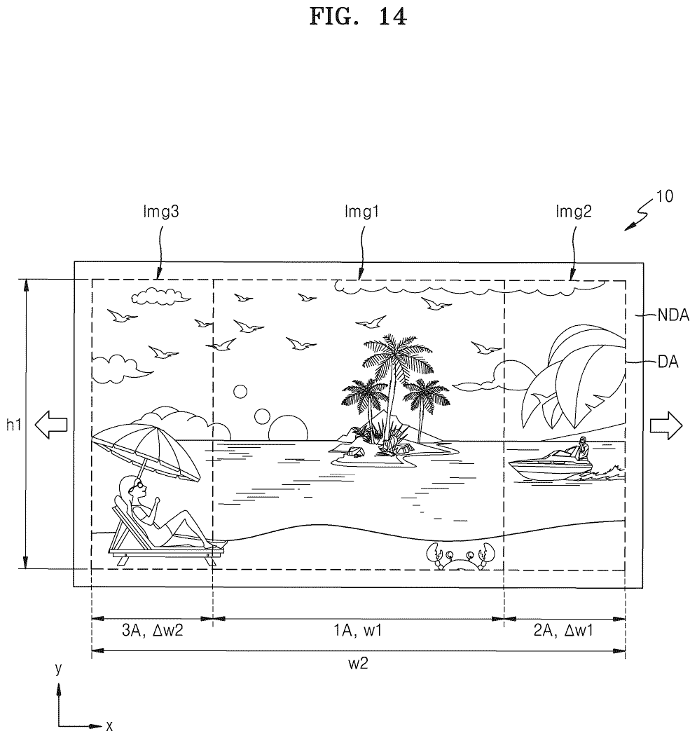

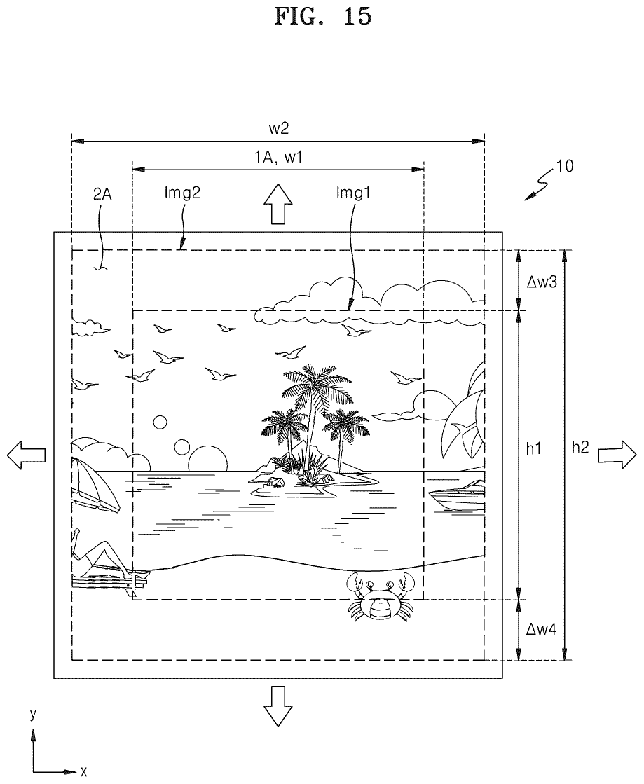

FIGS. 13A and 13B are schematic plan views of states in which the display panel 10 of FIG. 9 is stretched in the fourth direction. FIG. 14 is a schematic plan view of a state in which the display panel 10 of FIG. 9 is stretched in the first direction and the fourth direction. FIG. 15 is a schematic plan view of a state in which the display panel 10 of FIG. 9 is stretched in four directions.

Referring to FIGS. 13A and 13B, the display panel 10 may be stretched in the fourth direction (−x direction). The display area DA of the stretched display panel 10 may have a second width w2 in the first direction (x direction) and may have the first height h1 in the second direction (y direction). Because the number of pixels arranged in the display area DA of the display panel 10 does not change, the stretched display panel 10 may have the second resolution that is less than the first resolution.

The deformation detector 541 may generate the deformation data PSD including information on the deformation direction and deformation rate of the display panel 10 by using a strain sensor, and transmit the generated deformation data PSD to the controller 510. The controller 510 may identify the deformation rate and deformation direction of the display area DA from the deformation data PSD. For example, the controller 510 may identify an event in which the display area DA is stretched by the elongation width Δw in the fourth direction (−x direction) to have the second width w2, and may load third image data corresponding to the deformation rate and deformation direction of the display area DA from the memory 570. The third image data may include information of the first image Img1 having the first width w1 in the first direction (x direction) and the first height h1 in the second direction (y direction) at the second resolution, and information of a third image Img3 having the elongation width Δw in the fourth direction (−x direction) and the first height h1 in the second direction (y direction). The controller 510 may transmit, to the display panel 10, a display control signal DCS generated based on the third image data. The display panel 10 may display the first image Img1 on the first area 1A, which is a portion of the stretched display area DA, and may display the third image Img3 on a third area 3A, which is the remaining portion of the stretched display area DA. According to some embodiments, the controller 510 may control the display panel 10 so that the first area 1A on which the first image Img1 is displayed is fixed on the right side (x side) of the display area DA.

According to some embodiments, as illustrated in FIG. 13A, the third image Img3 may be the remaining portion of the user interface of the first software application. Each of the first image Img1 and the third image Img3 may be a portion of one image. For example, the first image Img1 may be a left portion of the entire image, and the third image Img3 may be a right portion of the entire image. The third image Img3 may be an image that is continuous from a left boundary of the first image Img1.

According to some embodiments, as illustrated in FIG. 13B, the third image Img3 may be a user interface of a third software application running in the background while the display area DA has the first size. That is, the user interface of the first software application may be provided to the first area 1A of the stretched display panel 10, and the user interface of the third software application may be provided to the second area 3A of the stretchable display panel 10.

Although the third software application is a system setting application in FIG. 13B, embodiments are not limited thereto. The third software application may be a variety of applications, such as a note-taking application and an Internet search application. According to some embodiments, a software application that is exposed may vary according to the deformation direction of the display panel 10, that is, according to a direction in which the user stretches the display panel 10.

Referring to FIG. 14, the display panel 10 may be stretched in the first direction (x direction) and/or the fourth direction (−x direction). For example, a pulling force is applied to the right (+x side) boundary and the left (−x side) boundary of the display panel 10, so that the display panel 10 may be stretched in the first direction (x direction) and the fourth direction (−x direction). The display area DA of the stretched display panel 10 may have the second width w2 in the first direction (x direction) and may have the first height h1 in the second direction (y direction). Because the number of pixels arranged in the display area DA of the display panel 10 does not change before and after the stretching, the stretched display panel 10 may have the second resolution that is less than the first resolution.

The controller 510 may identify an event in which the display area DA is stretched in the first direction (x direction) and the fourth direction (−x direction) to have the second width w2, and may load fourth image data corresponding to the deformation rate and deformation direction of the display area DA from the memory 570. The fourth image data may include information of the first image Img1 having the first width w1 in the first direction (x direction) and the first height h1 in the second direction (y direction), information of a second image Img2 having a first elongation width Δw1 in the first direction (x direction) and the first height h1 in the second direction (y direction), and information of a third image Img3 having a second elongation width Δw2 in the first direction (−x direction) and the first height h1 in the second direction (y direction). The controller 510 may transmit the fourth image data to the display panel 10, and thus the display panel 10 may display the first image Img1 on the first area 1A of the display area DA, the second image Img2 on the second area 2A, and the third image Img3 on the third area 3A. According to some embodiments, the controller 510 may control the display panel 10 so that a center portion of the first area 1A on which the first image Img1 is displayed is fixed on a center portion of the display area DA.

According to some embodiments, as illustrated in FIG. 14, each of the first image Img1, the second image Img2, and the third image Img3 may be a portion of one image. For example, the first image Img1 may be a center portion of the entire image, the second image Img2 may be a right portion of the entire image, and the third image Img3 may be a left portion of the entire image. The second image Img2 may be an image that is continuous from the left boundary of the first image Img1, and the third image Img3 may be an image that is continuous from the right boundary of the first image Img1.

Referring to FIG. 15, the display panel 10 may be stretched in the first direction (x direction), the second direction (y direction), the fourth direction (−x direction), and the fifth direction (−y direction). The display area DA of the display panel 10 in an initial state may have the first width w1 in the first direction (x direction) and may have the first height h1 in the second direction (y direction). The display area DA of the stretched display panel 10 may have the second width w2 in the first direction (x direction) and may have the second height h2 in the second direction (y direction). Because the number of pixels arranged in the display area DA of the display panel 10 does not change before the stretching and after the stretching, the stretched display panel 10 may have the second resolution that is less than the first resolution.

The controller 510 may identify an event in which the display area DA is stretched in the first direction (x direction), the second direction (y direction), the fourth direction (−x direction), and the fifth direction (−y direction), and may load fifth image data corresponding to the deformation rate and deformation direction of the display area DA from the memory 570. The fifth image data may include information of the first image Img1 having the first width w1 in the first direction (x direction) and the first height h1 in the second direction (y direction) at the second resolution, and information of the second image Img2. The controller 510 may transmit the fifth image data to the display panel 10, and thus the display panel 10 may display the first image Img1 on the first area 1A of the display area DA, and may display the second image Img2 on the second area 2A, which is outside the first area 1A. According to some embodiments, the controller 510 may control the display panel 10 so that a center portion of the first area 1A on which the first image Img1 is displayed is fixed on a center portion of the display area DA.

According to some embodiments, as illustrated in FIG. 15, each of the first image Img1 and the second image Img2 may be a portion of one image. For example, the first image Img1 may be a center portion of the entire image, and the second image Img2 may be an outer portion of the entire image. The second image Img2 may be an image that is continuous from four boundaries of the first image Img1.

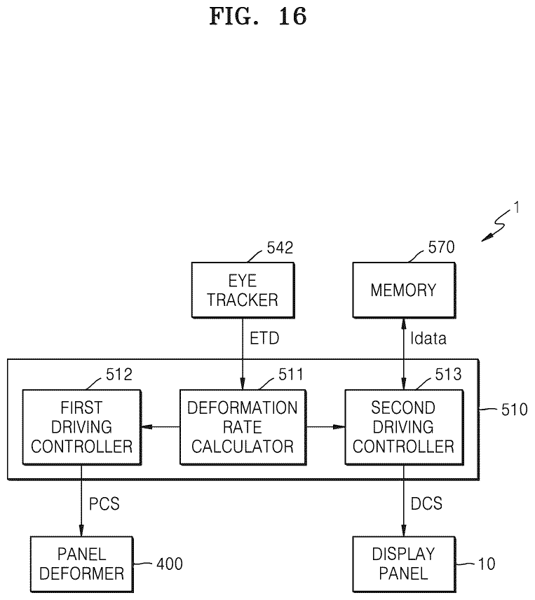

FIG. 16 is a schematic block diagram of the electronic apparatus 1 according to some embodiments.

Referring to FIG. 16, the electronic apparatus 1 may include the stretchable display panel 10, the panel deformer 400, the controller 510, an eye tracker 542, and the memory 570.

The display panel 10 may stretch or recover due to an external force applied by the panel deformer 400. The panel deformer 400 may include at least one arm fixed to the display panel 10, and a motor for driving the arm. The panel deformer 400 may transmit a panel-deformation control signal PCS from the controller 510 and may stretch or recover the display panel 10.

The eye tracker 542 may include an eye tracking sensor. For example, the eye tracker 542 may detect a location and movement of a user's eyes from an image obtained by the eye tracking sensor, to thereby generate tracking data ETD.

The controller 510 may include at least one processor. The controller 510 may include a deformation rate calculator 511, a first driving controller 512, and a second driving controller 513. Each of the deformation rate calculator 511, the first driving controller 512, and the second driving controller 513 may be a functional block implemented with various numbers of hardware and software configurations. Each of the deformation rate calculator 511, the first driving controller 512, and the second driving controller 513 may employ IC components including one or more processors. Alternatively, each of the deformation rate calculator 511, the first driving controller 512, and the second driving controller 513 may be implemented as, for example, an algorithm that is executed by at least one processor.

The deformation rate calculator 511 may receive the tracking data ETD from the eye tracker 542, and may calculate the deformation direction and deformation rate of the display panel 10 so that the display panel 10 is stretched according to the user's gaze direction. The first driving controller 512 may generate the panel deformation control signal PCS for controlling the panel deformer 400 according to the deformation direction and deformation rate of the display panel 10. The second driving controller 513 may load, from the memory 570, the image data Idata corresponding to the deformation direction and deformation rate (of the display panel 10. The second driving controller 513 may transmit the loaded image data Idata to the display panel 10, and the display panel 10 deformed by the panel deformer 400 may display an image.

According to some embodiments, before the display panel 10 is stretched, the display area DA may have the first size. Before the stretching, the display panel 10 may have a first resolution. The second driving controller 513 may load the first image data corresponding to the initial state from the memory 570, and transmit the first image data to the display panel 10. The first image data may include information corresponding to the first image having the first size at the first resolution. The display panel 10 may display a first image corresponding to the first image data on the entire surface of the display area DA.

The display panel 10 may be stretched by the panel deformer 400, and the stretched display area DA may have the second size. The second driving controller 513 may generate a display control signal DCS by loading second image data corresponding to the deformation direction and deformation rate of the display panel 10, and transmit the generated display control signal DCS to the display panel 10. The second image data may include information corresponding to a first image having a first size at a second resolution, which is a resolution after deformation, and information corresponding to a second image displayed outside the first image. The stretched display panel 10 may display the first image having the first size on a portion of the display area DA and display the second image on a remaining portion of the display area DA, in correspondence with the second image data.

When the user's gaze leaves the display panel 10 or returns to the display area DA in its initial state, the deformation rate calculator 511 may calculate the deformation direction and deformation rate of the display panel 10 so that the display area DA shrinks to the first size, based on the tracking data ETD. The first driving controller 512 may generate the panel deformation control signal PCS for controlling the panel deformer 400 according to the deformation direction and deformation rate of the display panel 10. The second driving controller 513 may load, from the memory 570, the first image data corresponding to the initial state in order to correspond to the deformation direction and deformation rate of the display panel 10. The second drive controller 513 may transmit the first image data to the display panel 10, and the display panel 10 may display the first image having the first size on the entire surface of the display area DA.

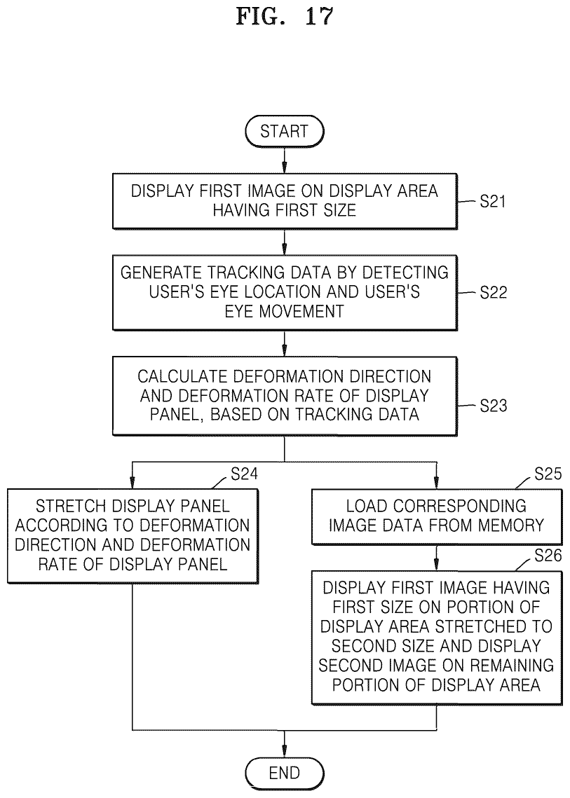

FIG. 17 is a schematic flowchart illustrating aspects of an operation method of the electronic apparatus 1, according to some embodiments. Although FIG. 17 illustrates various operations in an operation method of an electronic device according to some embodiments of the present disclosure, embodiments are not limited thereto, and according to some embodiments, there may be additional operations, or fewer operations, or the order of operations may vary, unless otherwise stated or implied, without departing from the spirit and scope of embodiments according to the present disclosure.

Referring to FIG. 17, the operation method of the electronic apparatus 1, according to some embodiments, may include operation S21 of displaying a first image on a display area having a first size, operation S22 of generating tracking data by detecting a user's eye location and the user's eye movement, operation S23 of calculating a deformation direction and a deformation rate of the display panel 10, based on the tracking data, operation S24 of stretching the display panel 10 according to the deformation direction and the deformation rate of the display panel 10, operation S25 of loading corresponding image data from a memory, and operation S26 of displaying the first image having the first size on a portion of the display area stretched to a second size and displaying a second image on the remaining portion of the display area.

In operation S21 of displaying the first image on the display area having the first size, the controller 510 may be configured to load the first image data from the memory 570 and transmit the first image data to the display panel 10. The display panel 10 may display the first image having the first size on the entire surface of the display area DA.

In operation S22 of generating the tracking data by detecting the user's eye location and the user's eye movement, the eye tracker 542 may detect the user's eye location and the user's eye movement by using an eye tracking sensor, convert the user's eye location and the user's eye movement into the tracking data ETD, and transmit the tracking data ETD to the controller 510.

In operation S23 of calculating the deformation direction and the deformation rate of the display panel 10, based on the tracking data, the controller 510 may determine the user's gaze direction from the tracking data ETD. The controller 510 may calculate the deformation direction and deformation rate of the display panel 10 for stretching the display area DA in the gaze direction of the user.

In operation S24 of stretching the display panel 10 according to the deformation direction and the deformation rate of the display panel 10, the controller 510 may generate the panel-deformation control signal PCS according to the calculated deformation direction and calculated deformation rate of the display panel 10 and transmit the panel-deformation control signal PCS to the panel deformer 400. The panel deformer 400 may stretch the display panel 10, based on the panel-deformation control signal PCS.

In operation S25 of loading the corresponding image data from the memory, the controller 510 may load, from the memory 570, the second image data corresponding to the deformation direction and deformation rate of the display panel 10. The operation S24 of stretching the display panel 10 according to the deformation direction and the deformation rate of the display panel 10, and the operation S25 of loading the corresponding image data from the memory may be substantially simultaneously performed.

In operation S26 of displaying the first image having the first size on the portion of the display area stretched to the second size and displaying the second image on the remaining portion, the controller 510 may transmit the second image data to the display panel 10, and the display panel 10 may display the first image having the first size on the portion of the display area DA and display the second image on the remaining portion.

The first image data may include information corresponding to the first image having the first size at the first resolution, which is a resolution of the display panel 10 in the initial state. The second image data may include information corresponding to a first image having a first size at a second resolution, which is a resolution of the display panel 10 that has been deformed, and information corresponding to a second image displayed outside the first image.

According to some embodiments, the operation method of the electronic apparatus 1 may further include controlling the panel deformer 400 so that the display area DA stretched to the second size recovers to the first size according to the deformation direction and the deformation rate of the display panel 10, loading the corresponding image data from the memory 570, based on the deformation direction and the deformation rate of the display panel 10, and displaying the first image on the display area DA recovered to have the first size.

In the controlling of the panel deformer 400 so that the display area DA stretched to the second size recovers to the first size according to a determined gaze direction,, the controller 510 may receive the tracking data ETD and may determine the user's gaze direction. When the user's gaze leaves the display panel 10 or returns to the display area DA of the display panel 10 that has not yet been stretched, the controller 510 may calculate the deformation direction and deformation rate of the display panel 10 for recovering the display area DA to the first size according to the gaze direction.

The controller 510 may generate the panel-deformation control signal PCS for controlling the panel deformer 400 according to the calculated deformation direction and deformation rate of the display panel 10. The panel deformer 400 may recover the display panel 10 to have the first size, according to the panel-deformation control signal PCS.

In the loading of the corresponding image data from the memory 570, based on the deformation direction and the deformation rate of the display panel 10, the controller 510 may load image data corresponding to the calculated deformation direction and calculated deformation rate of the display panel 10, i.e., the first image data, from the memory 570.

In the displaying of the first image on the display area DA recovered to have the first size, the controller 510 may generate the display control signal DCS, based on the first image data, and may transmit the display control signal DCS to the display panel 10. The display panel 10 may display the first image having the first size on the entire surface of the display area DA.

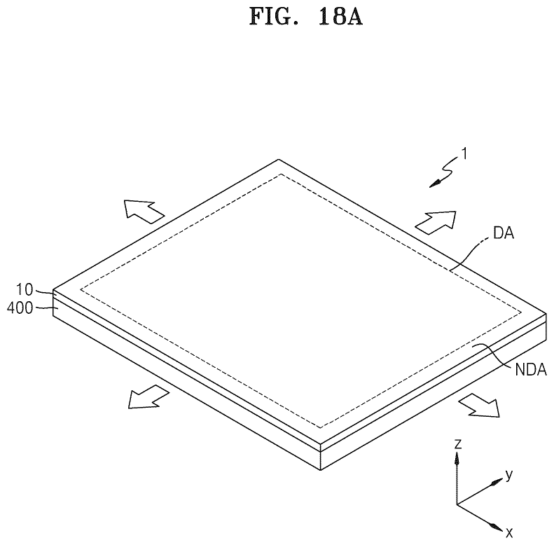

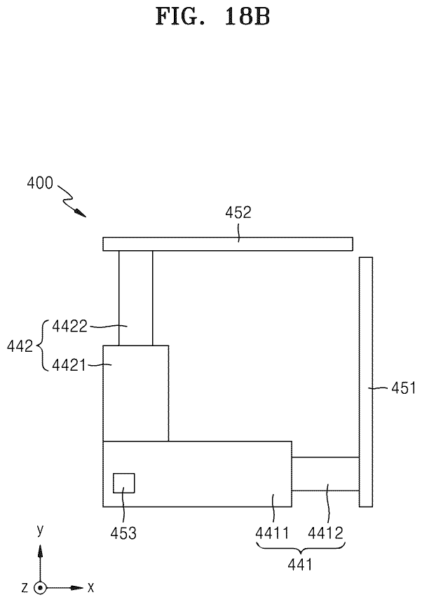

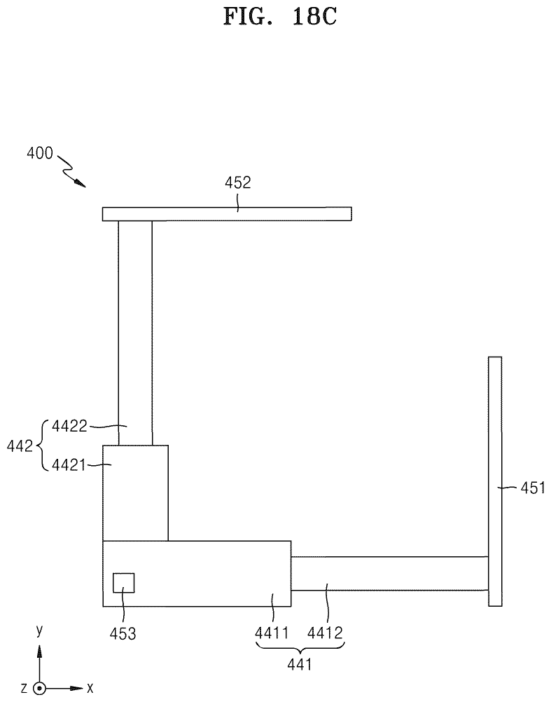

FIGS. 18A through 18C are schematic plan views of the panel deformer 400 according to some embodiments.

Referring to FIGS. 18A through 18C, the electronic apparatus 1 may include the display panel 10 and the panel deformer 400. The display panel 10 may include the display area DA and the non-display area NDA. According to some embodiments, the display panel 10 may stretch or recover in the first direction (x direction), the second direction (y direction), the fourth direction (−x direction), and the fifth direction (−y direction). The panel deformer 400 may be fixed to the display panel 10, and may provide a driving force to the display panel 10 such that the display panel 10 may stretch or recover in the first direction (x direction), the second direction (y direction), the fourth direction (−x direction), and the fifth direction (−y direction).

The panel deformer 400 may be connected to the display panel 10. The panel deformer 400 may be fixed to a back surface of the display panel 10. As illustrated in FIGS. 18B and 18C, the panel deformer 400 may include one or more arms, namely, first and second arms 441 and 442, that may stretch or recover in one direction, and first, second, and third connectors 451, 452, and 453 connected to the display panel 10.

The first connector 451 may extend in the second direction (y direction), and may be attached to an outer portion on the right side (+x side) of the display panel 10 to thereby connect the display panel 10 to the first arm 441. The second connector 452 may extend in the first direction (x direction), and may be attached to an outer portion on an upper side (+y side) of the display panel 10 to thereby connect the display panel 10 to the second arm 442. The third connector 453 may be attached to an outer portion of a lower left side (−x side and −y side) of the display panel 10, and may fix the display panel 10 to the first arm 441 and the second arm 442. The first connector 451, the second connector 452, and the third connector 453 may include an adhesive member, such as a pressure-sensitive adhesive, to fix the display panel 10 to the panel deformer 400.

The first arm 441 may move the first connector 451 in the first direction (x direction) or the fourth direction (−x direction). The first arm 441 may include a first portion 4411, and a second portion 4412 insertable into an empty space inside the first portion 4411. The second portion 4412 may be connected to the first connector 451. The first arm 441 may include a motor for moving the second portion 4412. The second portion 4412 may move along the first portion 4411 in the first direction (x direction) or the fourth direction (−x direction) to stretch the display panel 10 in the first direction (x direction) or recover the display panel 10 in the fourth direction (−x direction).

The second arm 442 may move the second connector 452 in the second direction (y direction) or the fifth direction (−y direction). The second arm 442 may include a third portion 4421, and a fourth portion 4422 insertable into an empty space inside the third portion 4421. The fourth portion 4422 may be connected to the second connector 452. The second arm 442 may include a motor for moving the fourth portion 4422. The fourth portion 4422 may move along the third portion 4421 in the second direction (y direction) or the fifth direction (−y direction) to stretch the display panel 10 in the second direction (y direction) or recover the display panel 10 in the fifth direction (−y direction).

Although FIGS. 18B and 18C disclose the panel deformer 400 including two arms, embodiments are not limited thereto. The panel deformer 400 may be designed in various ways, such as including one arm or four arms.

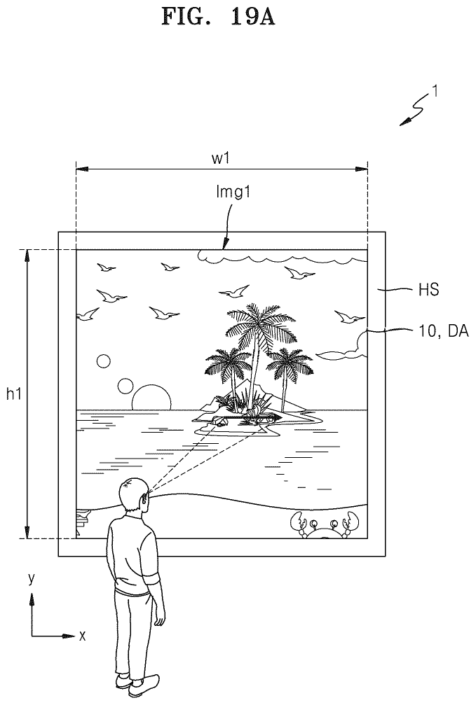

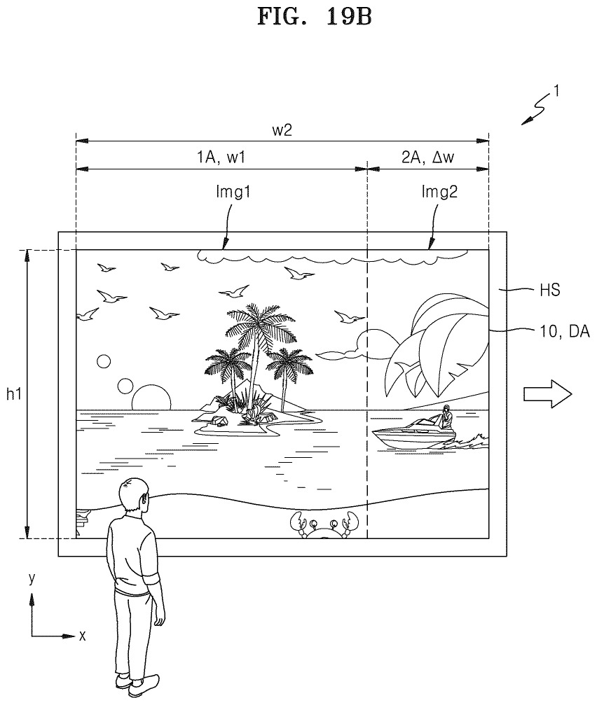

FIG. 19A is a schematic view illustrating the electronic apparatus 1 according to some embodiments, and FIG. 19B is a schematic view illustrating a state in which the electronic apparatus 1 of FIG. 19A has been stretched in the first direction.

Referring to FIG. 19A, the electronic apparatus 1 may include the display panel 10 and a housing HS. The housing HS may form the exterior of the electronic apparatus 1, and may expose the display area DA of the display panel 10 on a front surface of the housing HS. The housing HS may be connected to the panel deformer 400 and thus may stretch or recover together with the display panel 10.

Before the display panel 10 is stretched, the display area DA may have the first size. The display area DA may have the first width w1 in the first direction (x direction) and may have the first height h1 in the second direction (y direction). Before the stretching, the display panel 10 may have a first resolution. The controller 510 may load the first image data from the memory 570, and may transmit, to the display panel 10, a display control signal DCS generated based on the first image data. The first image data may include information of the first image Img1 having the first width w1 in the first direction (x direction) and the first height h1 in the second direction (y direction) at the first resolution. The controller 510 may control the display panel 10 to display the first image Img1 on the entire surface of the display area DA.

The eye tracker 542 may detect a location and movement of a user's eyes to thereby generate the tracking data ETD. The controller 510 may determine the gaze direction of the user from the tracking data ETD. The deformation rate calculator 511 of the controller 510 may calculate the deformation direction and deformation rate of the display panel 10 in order to stretch the display area DA in the determined gaze direction of the user.

For example, when the gaze direction of the user moves in the first direction (x direction), the display panel 10 may stretch in the first direction (x direction). The controller 510 may control the panel deformer 400 according to the deformation direction and deformation rate of the display panel 10. The display panel 10 may be stretched in the first direction (x direction) by the panel deformer 400. The display area DA of the stretched display panel 10 may have the second width w2 in the first direction (x direction) and may have the first height h1 in the second direction (y direction). Because the number of pixels arranged in the display area DA of the display panel 10 does not change, the stretched display panel 10 may have the second resolution that is less than the first resolution.

The controller 510 may load second image data corresponding to the deformation direction and deformation rate of the display panel 10 from the memory 570. The second image data may include information of the first image Img1 having the first size at the second resolution, and information of the second image Img2 outside the first image Img1. The controller 510 may transmit, to the display panel 10, a display control signal DCS generated based on the second image data. The display panel 10 may display the first image Img1 on the first area 1A of the display area DA, and may display the second image Img2 on the second area 2A of the display area DA.

The first area 1A may have a first size that is substantially the same as the size of the display area DA of the display panel 10 in the initial state. The first area 1A may have the first width w1 in the first direction (x direction) and may have the first height h1 in the second direction (y direction). Therefore, even after deformation of the display panel 10, the first image Img1 may be displayed with substantially the same size. The second area 2A may be an area outside the first area 1A in the stretched display area DA.

According to some embodiments, each of the first image Img1 and the second image Img2 may be a portion of one image. For example, as illustrated in FIG. 19B, the first image Img1 may be a left portion of the entire image, and the second image Img2 may be a right portion of the entire image. The second image Img2 may be an image that is continuous from the right boundary of the first image Img1. The controller 510 may control the display panel 10 so that the first area 1A on which the first image Img1 is displayed is fixed based on the user. For example, when the user's gaze direction moves in the first direction (x direction), the controller 510 may control the display panel 10 so that the first area 1A on which the first image Img1 is displayed is fixed on the left (−x direction) boundary of the display area DA.

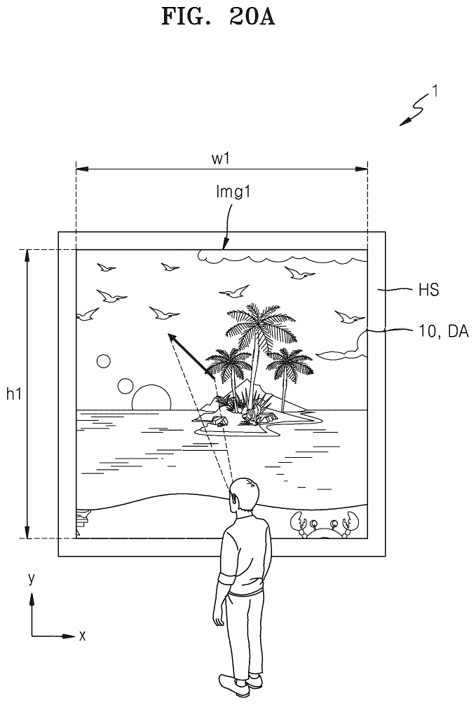

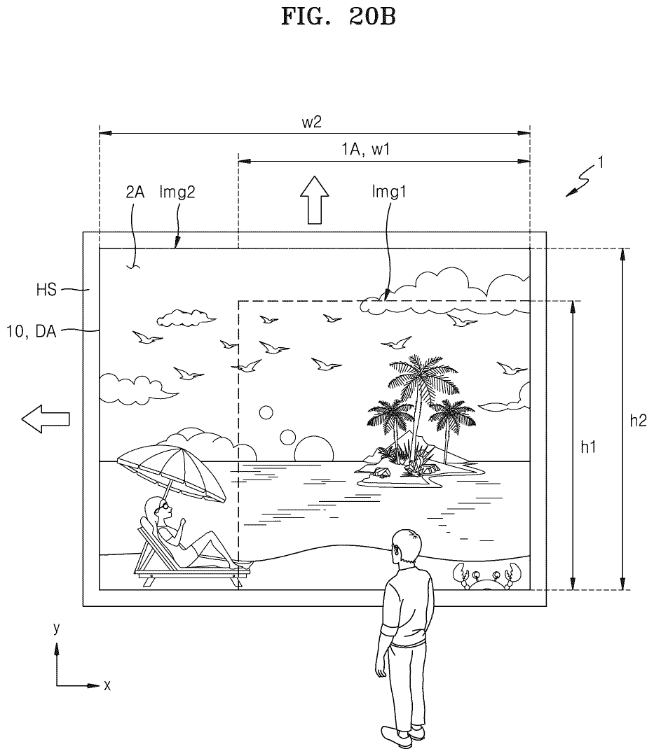

FIG. 20A is a schematic view illustrating the electronic apparatus 1 according to some embodiments, and FIG. 20B is a schematic view illustrating a state in which the electronic apparatus 1 of FIG. 20A has been stretched in the second direction and the fourth direction.

Referring to FIGS. 20A and 20B, the display panel 10 may be stretched in two or more directions, according to the gaze direction of the user. Before the display panel 10 is stretched, the display area DA may have the first size. For example, the display area DA may have the first width w1 in the first direction (x direction) and may have the first height h1 in the second direction (y direction). The display panel 10 having the first size may have a first resolution.

The controller 510 may load the first image data from the memory 570, and may transmit, to the display panel 10, a display control signal DCS generated based on the first image data. The first image data may include information of a first image Img1 having the first size at the first resolution. The display panel 10 may display the first image Img1 on the entire surface of the display area DA.

The eye tracker 542 may detect a location and movement of the user's eyes to thereby generate the tracking data ETD. The controller 510 may determine the gaze direction of the user from the tracking data ETD. The controller 510 may calculate the deformation direction and deformation rate of the display panel 10 in order to stretch the display area DA in the gaze direction of the user, for example, the second direction (y direction) and the fourth direction (−x direction).

For example, as illustrated in FIG. 20A, when the user's gaze direction moves in a diagonal direction toward an upper left side, the controller 510 may control the panel deformer 400 so that the display panel 10 stretches in the second direction (y direction) and the fourth direction (−x direction). The controller 510 may control the panel deformer 400 according to the deformation direction and deformation rate of the display panel 10. The display area DA of the stretched display panel 10 may have a second size. The display area DA of the stretched display panel 10 may have the second width w2 greater than the first width w1 in the first direction (x direction) and may have the second height h2 greater than the first height h1 in the second direction (y direction). The stretched display panel 10 may have a seond resolution less than the first resolution.

The controller 510 may load second image data corresponding to the calculated deformation direction and calculated deformation rate of the display panel 10 from the memory 570. The second image data may include information of the first image Img1 having the first size at the second resolution, and information of a second image Img2. The controller 510 may transmit, to the display panel 10, a display control signal DCS generated based on the second image data. The stretched display panel 10 may display the first image Img1 on the first area 1A, which is a portion of the display area DA, according to the display control signal DCS, and may display the second image Img2 on the second area 2A, which is the remaining portion of the display area DA.

The first area 1A may have substantially the same size as a size of the display area DA of the stretched display panel 10. The first area 1A may have the first width w1 in the first direction (x direction) and may have the first height h1 in the second direction (y direction). Therefore, even after deformation of the display panel 10, the first image Img1 may be displayed with substantially the same size. A location at which the first area 1A is displayed is fixed based on the user, so that the user may recognize that the size and location of the first image Img1 are fixed while the display panel 10 is being stretched. For example, when the user's gaze direction lengthens in the second direction (y direction) and the fourth direction (−x direction), the controller 510 may control the display panel 10 so that the first area 1A on which the first image Img1 is displayed is fixed on the right (+x direction) boundary and the left (−y direction) boundary of the display area DA. The second area 2A may be an area outside the first area 1A.

According to some embodiments, each of the first image Img1 and the second image Img2 may be a portion of one image. For example, as illustrated in FIG. 20B, the first image Img1 may include a lower right portion of the entire image, and the second image Img2 may include a left portion and an upper portion of the entire image. The second image Img2 may be an image that is continuous from the left boundary and the upper boundary of the first image Img1. The electronic apparatus 1 according to some embodiments may provide a new user experience by naturally stretching or recovering the display panel 10 according to a movement of a user's gaze.

According to some embodiments as described above, an electronic apparatus including a stretchable display panel that relatively reduces image distortion caused by deformation of the display panel and provides a new user interface, and an operation method of the electronic apparatus may be realized. Of course, the scope of the disclosure is not limited thereto.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electronic apparatus including a stretchable display panel, the electronic apparatus comprising:
the stretchable display panel including a display area and a peripheral area outside the display area;
a deformation detector configured to detect a deformation direction and deformation rate of the stretchable display panel to generate deformation data;
a memory storing a plurality of image data; and
at least one processor,
wherein the at least one processor is configured to receive the deformation data, to identify an event in which the display area having a first size is stretched to a second size while displaying a first image having the first size, and to control the stretchable display panel to display the first image having the first size on a portion of the display area and display a second image on a remaining portion of the display area.

2. The electronic apparatus of claim 1, wherein the at least one processor is configured to load first image data from the memory based on the display area having the first size, to generate a display control signal based on the first image data, transmit the display control signal to the stretchable display panel, to load second image data from the memory based on the display area having the second size, to generate the display control signal based on the second image data, and to transmit the display control signal to the stretchable display panel.

3. The electronic apparatus of claim 2, wherein
the first image data includes information of the first image having the first size at a first resolution, and
the second image data includes information of the first image having the first size at a second resolution, and information of the second image.

4. The electronic apparatus of claim 1, wherein each of the first image and the second image is a portion of one image.

5. The electronic apparatus of claim 1, wherein
the at least one processor is configured to execute a first software application in a foreground state and to execute a second software application in a background state, based on the display area having the first size,
the first image is a user interface of the first software application, and
the second image is a user interface of the second software application.

6. The electronic apparatus of claim 1, wherein the at least one processor is configured to identify a deformation direction of the stretchable display panel and to determine a location of the first image on the display area according to the deformation direction.

7. The electronic apparatus of claim 6, wherein the at least one processor is configured to fix a boundary of the first image at one side of the display area based on the stretchable display panel being stretched.

8. The electronic apparatus of claim 6, wherein the at least one processor is configured to fix a center portion of the first image at a center portion of the display area based on the stretchable display panel being stretched.

9. An electronic apparatus including a stretchable display panel, the electronic apparatus comprising:
the stretchable display panel including a display area and a peripheral area outside the display area;
a panel deformation device configured to stretch or recover the stretchable display panel;
an eye tracker configured to detect an eye location and an eye movement of a user to generate tracking data;
a memory storing a plurality of image data; and
at least one processor,
wherein the at least one processor is configured to receive the tracking data, to calculate a deformation direction and a deformation rate of the stretchable display panel, based on the tracking data based on the display area having a first size is displaying a first image having the first size, to control the panel deformation device to have a second size according to the deformation direction and the deformation rate, and to control the stretchable display panel to display the first image having the first size on a portion of the display area and display a second image on a remaining portion of the display area.

10. The electronic apparatus of claim 9, wherein the at least one processor is configured to load first image data from the memory based on the display area having the first size, to generate a display control signal based on the first image data, transmit the display control signal to the stretchable display panel, to load second image data from the memory based on the display area having the second size, to generate the display control signal based on the second image data, and to transmit the display control signal to the stretchable display panel.

11. The electronic apparatus of claim 10, wherein
the first image data includes information of the first image having the first size at a first resolution, and
the second image data includes information of the first image having the first size at a second resolution, and information of the second image.

12. The electronic apparatus of claim 11, wherein each of the first image and the second image is a portion of one image.

13. An operation method of an electronic apparatus including a stretchable display panel, the operation method comprising:
displaying a first image on a display area having a first size;
generating deformation data including a deformation direction and deformation rate of the stretchable display panel;
loading corresponding image data from a memory according to the deformation data; and
displaying the first image having the first size on a portion of the display area stretched to a second size, and displaying a second image on a remaining portion of the display area.

14. The operation method of claim 13, wherein
the electronic apparatus further includes a deformation detector which detects the deformation direction and the deformation rate of the stretchable display panel,
the deformation direction and the deformation rate of the stretchable display panel are detected based on changes in electrical or optical characteristics of the deformation detector.

15. The operation method of claim 13, wherein
in the displaying of the first image on the display area having the first size, the first image is displayed at a first resolution, and
in the displaying of the first image on the portion of the display area having the second size and the displaying of the second image on the remaining portion of the display area, the first image and the second image are displayed at a second resolution less than the first resolution.

16. The operation method of claim 13, wherein each of the first image and the second image is a portion of one image.

17. The operation method of claim 13, wherein
in the displaying of the first image on the display area having the first size, a first software application is executed in a foreground state, and a second software application is executed in a background state,
the first image is a user interface of the first software application, and
the second image is a user interface of the second software application.

18. The operation method of claim 13, wherein
the displaying of the first image on the portion of the display area having the second size and the displaying of the second image on the remaining portion of the display area comprises
determining a location of the first image on the display area according to the deformation direction.

19. The operation method of claim 13, further comprising:
controlling a panel deformation device configured to stretch or recover the stretchable display panel so that the display area has a second size according to the deformation direction and the deformation rate;
wherein the generation the deformation data comprises:
detecting an eye location and an eye movement of a user to generate tracking data; wherein the detecting is performed by an eye tracker; and
calculating a deformation direction and a deformation rate of the stretchable display panel, based on the tracking data.

20. The operation method of claim 18, further comprising:
controlling the panel deformation device so that the display area stretched recovers to the first size according to the deformation data;
loading corresponding image data from a memory according to the data; and
displaying the first image on a display area having the first size.
